(19) United States
(12) Patent Application Publication
(10) Pub. No.: US 2025/0138330 A1
(43) Pub. Date: May 1, 2025

(54) OPTICAL ELEMENT, LASER MODULE, RETINAL PROJECTION DEVICE, AND NEAR-EYE WEARABLE DEVICE

(71) Applicant: TDK Corporation, Tokyo (JP)

(72) Inventors: Atsushi SHIMURA, Tokyo (JP); Yasuhiro TAKAGI, Tokyo (JP); Hiroki HARA, Tokyo (JP)

(73) Assignee: TDK Corporation, Tokyo (JP)

(21) Appl. No.: 18/883,273

(22) Filed: Sep. 12, 2024

(30) Foreign Application Priority Data
Oct. 27, 2023 (JP) 2023-184920

(51) Int. Cl. G02B 27/28; G02B 27/01

(52) U.S. Cl. CPC G02B 27/286; G02B 27/0172; G02B 27/283; G02B 2027/0178

(57) ABSTRACT

An optical element includes a mode converter that converts a polarization mode of visible light. The mode converter includes a conversion unit that converts a polarization mode of the visible light from a TM0 mode to a TE1 mode, and a splitting unit that splits the visible light in the TE1 mode into a first split light in the TE0 mode and a second split light in the TE0 mode, and adjusts a phase difference between the first split light and the second split light. The splitting unit includes a first branch wave guide through which the first split light propagates and a second branch wave guide through which the second split light propagates. An optical path length of the first split light in the first branch wave guide and an optical path length of the second split light in the second branch wave guide are different from each other.

### CROSS-REFERENCE TO RELATED APPLICATIONS

This application is based on and claims the benefit of priority from Japanese Patent Application No. 2023-184920 filed on Oct. 27, 2023, the entire contents of which are incorporated herein by reference.

### TECHNICAL FIELD

The present disclosure relates to an optical element, a laser module, a retinal projection device, and a near-eye wearable device.

### BACKGROUND

Polarization modes of light propagating through an optical waveguide include a transverse electric (TE) mode which is a polarization mode having a main electric field in a horizontal direction with respect to a substrate, and a transverse magnetic (TM) mode which is a polarization mode having a main electric field in a vertical direction with respect to the substrate. An optical element that converts these polarization modes is known.

For example, Japanese Unexamined Patent Publication No. 2017-181611 discloses an optical element that converts a polarization mode of light from a TM0 mode to a TE0 mode. This optical element includes a mode conversion unit that converts the polarization mode of light from the TM0 mode to a TE1 mode, a mode splitting unit that converts the polarization mode of light from the TE1 mode to two TE0 modes having phases different from each other, a phase adjustment unit that adjusts phases of light of the two TE0 modes, and a multiplexing unit that multiplexes the light of the two TE0 modes having adjusted phases.

### SUMMARY

The optical element described in Japanese Unexamined Patent Publication No. 2017-181611 is an optical element used for optical communication, and converts light in the TM0 mode in an infrared wavelength band into the light in the TE0 mode. However, in the optical element described in Japanese Unexamined Patent Publication No. 2017-181611, conversion efficiency on converting the light in the TM0 mode into the light in the TE0 mode is not considered, and conversion of visible light in the TM0 mode into visible light in the TE0 mode is not considered.

The present disclosure describes an optical element, a laser module, a retinal projection device, and a near-eye wearable device capable of converting a polarization mode of visible light from the TM0 mode to the TE0 mode while suppressing a decrease in conversion efficiency.

An optical element according to one aspect of the present disclosure includes: a substrate including a main surface; and a core layer that is provided on the main surface and consists of a material having an electro-optical effect. The core layer includes a mode converter that extends in a first direction along the main surface and converts a polarization mode of visible light from a TM0 mode to a TE0 mode. The mode converter includes a conversion unit that converts the polarization mode of visible light from the TM0 mode to a TE1 mode, a splitting unit that splits the visible light in the TE1 mode into a first split light in the TE0 mode and a second split light in the TE0 mode and adjusts a phase difference between the first split light and the second split light, and a multiplexing unit that multiplexes the first split light and the second split light. The conversion unit includes a first end to which the visible light in the TM0 mode is incident and a second end from which the visible light in the TE1 mode is emitted, the first end and the second end being both ends in a first direction. A length of the conversion unit in a second direction along the main surface and intersecting the first direction continuously increases from the first end to the second end. The phase difference is a phase difference obtained by subtracting a phase of the first split light when incident to the multiplexing unit from a phase of the second split light when incident to the multiplexing unit. The splitting unit includes a first branch wave guide through which the first split light propagates and a second branch wave guide through which the second split light propagates. An optical path length of the first split light in the first branch wave guide and an optical path length of the second split light in the second branch wave guide are different from each other.

In this optical element, since the length of the conversion unit in the second direction continuously increases from the first end to the second end, an effective refractive index of visible light propagating through the conversion unit varies. As a result, in the conversion unit, the polarization mode of the visible light can be converted from the TM0 mode to the TE1 mode. Further, in the splitting unit, the visible light in the TE1 mode emitted from the conversion unit is split into the first split light in the TE0 mode and the second split light in the TE0 mode having phases opposite to each other. Then, the first split light propagates through the first branch wave guide, and the second split light propagates through the second branch wave guide. Then, the multiplexing unit multiplexes the first split light and the second split light to emit the visible light in the TE0 mode.

Here, in a case where the optical path length in the first branch wave guide is the same as the optical path length in the second branch wave guide, the first split light and the second split light are incident to the multiplexing unit without changing the phase difference obtained by subtracting the phase of the first split light when incident to the multiplexing unit from the phase of the second split light when incident to the multiplexing unit from −π radians. Therefore, an optical intensity of the visible light obtained by multiplexing the first split light and the second split light is substantially the half of the optical intensity of the visible light incident to the conversion unit, and conversion efficiency decreases. On the other hand, in this optical element, since the optical path length in the first branch wave guide and the optical path length in the second branch wave guide are different from each other, the above-described phase difference has a value different from −π radians. This makes it possible to suppress reduction of the optical intensity of the visible light obtained by multiplexing the first split light and the second split light from the optical intensity of the visible light incident to the conversion unit. As described above, the optical element can convert the polarization mode of the visible light from the TM0 mode to the TE0 mode while suppressing a decrease in conversion efficiency.

The above-described phase difference may be −2π/3+2nπ radians or more and −π/3+2nπ radians or less. n may be an integer. When the above-described phase difference is −π/2+2nπ radians, the optical intensity of the visible light in the TE0 mode obtained by multiplexing the first split light and the second split light is substantially the same as the optical intensity of the visible light in the TM0 mode incident to the conversion unit. As the above-described phase difference separates from −π/2+2nπ radians, the optical intensity of the visible light in the TE0 mode obtained by multiplexing the first split light and the second split light decreases. Since this range is a range of ±π/6 centered at −π/2+2nπ radians, the loss of the optical intensity of the visible light in the TE0 mode obtained by multiplexing the first split light and the second split light can be further reduced. That is, it is possible to further suppress the decrease in conversion efficiency from the TM0 mode to the TE0 mode.

The core layer may further include a slab provided on the main surface. The mode converter may be provided on the slab in a third direction intersecting the first direction and the second direction. In this case, the waveguide formed by the conversion unit and the slab has an asymmetric shape in the third direction. Therefore, the conversion efficiency from the TM0 mode to the TE1 mode in the conversion unit can be improved.

A length of the core layer in the third direction may be smaller than a wavelength of visible light. In this case, the visible light is likely to be leaked from the conversion unit to the slab. Therefore, the conversion efficiency from the TM0 mode to the TE1 mode in the conversion unit can be improved.

The multiplexing unit may include a multimode interferometer. In this case, the multiplexing unit can be easily manufactured as compared with a case where the multiplexing unit is manufactured by a Y-branch waveguide.

A length of the multiplexing unit in the second direction may be 2.0 μm or more. In this case, an interval between the first branch wave guide and the second branch wave guide can be secured without reducing the widths of the first branch wave guide and the second branch wave guide. Therefore, the first branch wave guide and the second branch wave guide can have desired shapes.

A length of the first branch wave guide in the second direction at a connection end connected to the multiplexing unit of the first branch wave guide may be 23% or more and 47% or less of the length of the multiplexing unit in the second direction. A length of the second branch wave guide in the second direction at a connection end connected to the multiplexing unit of the second branch wave guide may be 23% or more and 47% or less of the length of the multiplexing unit in the second direction. In this case, both a tolerance of the mode converter with respect to a manufacturing error and the like and the interval between the first branch wave guide and the second branch wave guide can be secured.

The core layer may include a first mode converter that is the mode converter which converts a polarization mode of red light from the TM0 mode to the TE0 mode, a second mode converter that is the mode converter which converts a polarization mode of green light from the TM0 mode to the TE0 mode, a third mode converter that is the mode converter which converts a polarization mode of blue light from the TM0 mode to the TE0 mode, and a multiplexer which multiplexes the red light, the green light, and the blue light to emit laser light. According to this configuration, the polarization mode of the red light is converted from the TM0 mode to the TE0 mode, the polarization mode of the green light is converted from the TM0 mode to the TE0 mode, and the polarization mode of the blue light is converted from the TM0 mode to the TE0 mode. For example, when the multiplexer is designed such that multiplexing efficiency in a case of multiplexing the red light, the green light, and the blue light in the TE0 mode is higher than multiplexing efficiency in a case of multiplexing the red light, the green light, and the blue light in the TM0 mode, the multiplexing efficiency in the multiplexer can be improved.

A length of the first mode converter in a third direction intersecting the first direction and the second direction, a length of the second mode converter in the third direction, and a length of the third mode converter in the third direction may be the same as each other. In this case, since the first mode converter, the second mode converter, and the third mode converter can be formed on the same substrate, and the lengths of the respective mode converters in the third direction can be made the same as each other, the optical element can be easily manufactured.

The core layer may include a first modulator which modulates an optical intensity of the red light, a second modulator which modulates an optical intensity of the green light, and a third modulator which modulates an optical intensity of the blue light. In order to output full-color laser light by multiplexing the red light, the green light, and the blue light, it is necessary to adjust the optical intensity of light of each color in correspondence with the color to be output. According to the above configuration, since the optical intensity of the red light, the optical intensity of the green light, and the optical intensity of the blue light are modulated, it is possible to output full-color laser light.

A laser module according to another aspect of the present disclosure includes the optical element described above, a first laser light source which emits the red light in the TM0 mode, a second laser light source which emits the green light in the TM0 mode, and a third laser light source which emits the blue light in the TM0 mode. Since this laser module includes the above-described optical element, it is possible to convert the polarization mode of the visible light from the TM0 mode to the TE0 mode while suppressing the decrease in conversion efficiency.

A retinal projection device according to still another aspect of the present disclosure is a device mounted on a near-eye wearable device, and includes the above-described laser module, a movable mirror which performs scanning by using laser light emitted from the laser module, and a reflector which reflects the laser light that has passed through the movable mirror and guides the laser light to a retina of a user wearing the near-eye wearable device to project an image onto the retina. The retinal projection device includes the above-described optical element. Therefore, in the retinal projection device, it is possible to convert the polarization mode of the visible light from the TM0 mode to the TE0 mode and then project an image onto the retina while suppressing the decrease in conversion efficiency.

A near-eye wearable device according to still another aspect of the present disclosure includes the above-described retinal projection device and a lens provided with the above-described reflector. The near-eye wearable device includes the retinal projection device including the above-described optical element. Therefore, in the near-eye wearable device, it is possible to convert the polarization mode of the visible light from the TM0 mode to the TE0 mode and then project an image onto the retina while suppressing the decrease in conversion efficiency.

According to each aspect and each embodiment of the present disclosure, the polarization mode of the visible light can be converted from the TM0 mode to the TE0 mode while suppressing the decrease in conversion efficiency.

### BRIEF DESCRIPTION OF THE DRAWINGS

FIG. 1 is a perspective view illustrating an appearance of a near-eye wearable device to which a laser module according to an embodiment is applied;

FIG. 2 is a configuration diagram schematically illustrating a retinal projection device illustrated in FIG. 1;

FIG. 3 is a block diagram of a laser module illustrated in FIG. 2;

FIG. 4 is a diagram illustrating a cross-sectional configuration of an optical element illustrated in FIG. 3;

FIG. 5 is a plan view illustrating a configuration of a mode converter illustrated in FIG. 3;

FIG. 6 is an enlarged plan view illustrating a splitting unit illustrated in FIG. 5;

FIG. 7 is a block diagram of a laser module according to another embodiment;

FIG. 8 is a block diagram of a laser module according to still another embodiment;

FIG. 9 is a block diagram of a laser module according to still another embodiment;

FIG. 10A is a diagram illustrating evaluation results of Example 1;

FIG. 10B is a diagram illustrating evaluation results of Example 2;

FIG. 10C is a diagram illustrating evaluation results of Example 3;

FIG. 11A is a diagram illustrating a relationship between a length of a conversion unit in an X-axis direction and a conversion loss;

FIG. 11B is a diagram illustrating a relationship between the length of the conversion unit in the X-axis direction and the conversion loss;

FIG. 11C is a diagram illustrating a relationship between the length of the conversion unit in the X-axis direction and the conversion loss;

FIG. 12A is a diagram illustrating evaluation results of Example 10 to Example 13;

FIG. 12B is a diagram illustrating evaluation results of Example 14 to Example 17; and

FIG. 12C is a diagram illustrating evaluation results of Example 18 to Example 23.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction (second direction) is a direction intersecting (for example, orthogonal to) the X-axis direction (first direction) and the Z-axis direction (third direction). The Z-axis direction is a direction intersecting (for example, orthogonal to) the X-axis direction and the Y-axis direction. In the present specification, the numerical ranges indicated by “to” represent ranges that include the values described before and after “to” as the minimum and maximum values, respectively. The individually described upper and lower limit values can be combined arbitrarily.

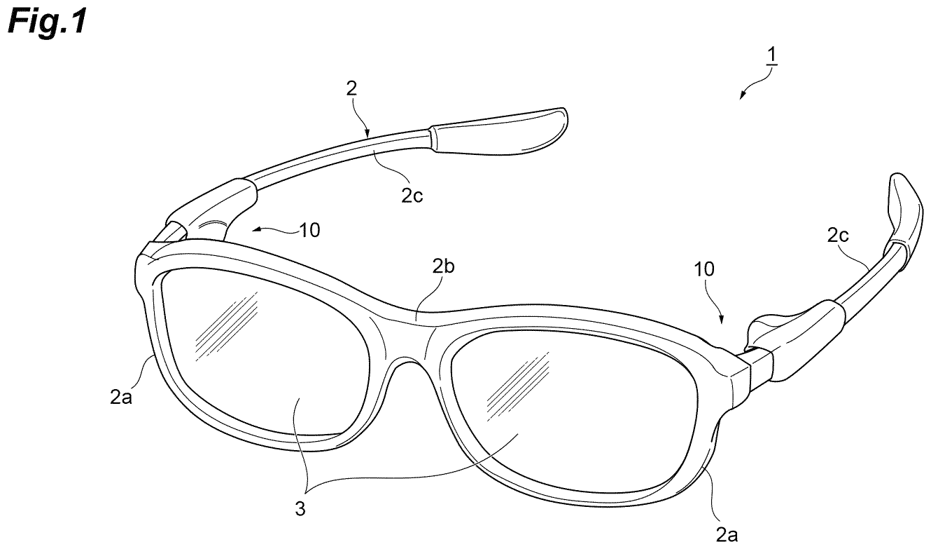

An application example of a laser module according to an embodiment will be described with reference to FIG. 1. FIG. 1 is a perspective view illustrating an appearance of a near-eye wearable device to which the laser module according to an embodiment is applied. The near-eye wearable device 1 illustrated in FIG. 1 is a device that projects images onto the retina of a user wearing the near-eye wearable device 1. The near-eye wearable device 1 is, for example, a head-mounted device, and may take the form of an eyeglass type, a goggle type, a hat type, a helmet type, or the like. Examples of the near-eye wearable device 1 include smart glasses such as augmented reality (AR) glasses, virtual reality (VR) glasses, and mixed reality (MR) glasses. The near-eye wearable device 1 includes a frame 2, a lens 3, and a retinal projection device 10.

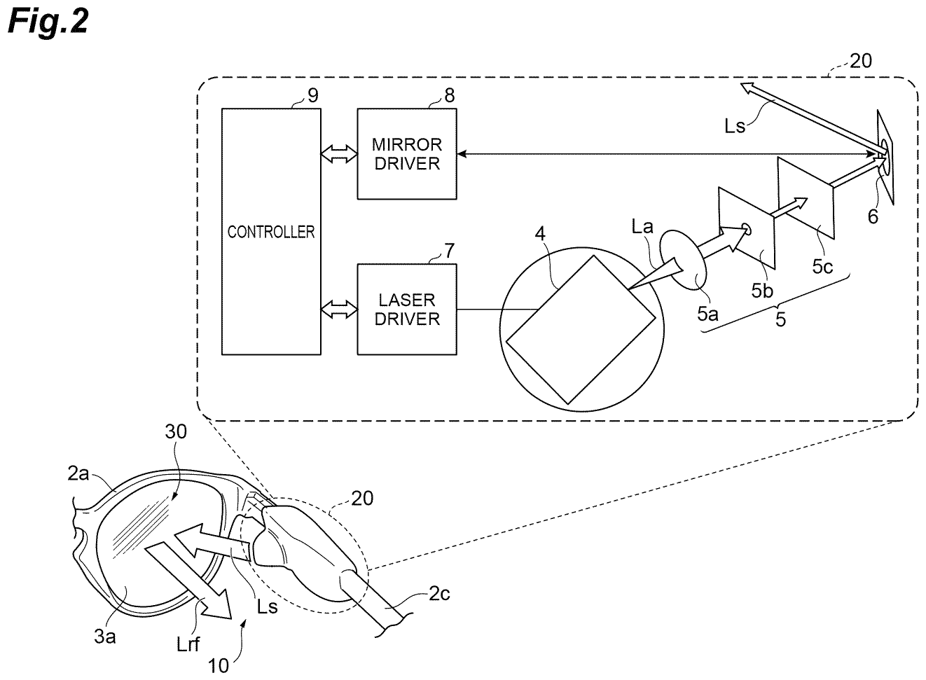

The frame 2 includes a pair of rims 2a, a bridge 2b, and a pair of temples 2c. The rim 2a is a portion for holding the lens 3. The bridge 2b is a portion connecting the pair of rims 2a. The temple 2c extends from the rim 2a and is a portion to be put on an ear of a user. The frame 2 may be a rimless frame. The lens 3 includes an inner surface 3a (refer to FIG. 2) facing an eyeball of a user wearing the near-eye wearable device 1.

The retinal projection device 10 is a device for directly projecting (drawing) an image onto a retina of a user wearing the near-eye wearable device 1. The retinal projection device 10 is mounted on the near-eye wearable device 1. In the present embodiment, the near-eye wearable device 1 includes two retinal projection devices 10 in order to project an image onto both the right and left retinas, but may include only one of the retinal projection devices 10.

Next, the retinal projection device 10 will be described in detail with reference to FIG. 2. FIG. 2 is a configuration diagram schematically illustrating the retinal projection device illustrated in FIG. 1. As illustrated in FIG. 2, the retinal projection device 10 includes an optical engine 20 and a reflector 30.

The optical engine 20 is a device which generates a laser light Ls having a color and optical intensity corresponding to a pixel of an image to be projected onto the retina and emits the laser light Ls to the reflector 30. The optical engine 20 is mounted on each temple 2c. The optical engine 20 includes a laser module 4, optical components 5, a movable mirror 6, a laser driver 7, a mirror driver 8, and a controller 9.

The laser module 4 emits a laser light La, which is visible light. As the laser module 4, for example, a full-color laser module is used.

The laser module 4 emits a laser light La having a color and optical intensity corresponding to a pixel of an image to be projected onto the retina. Details of the laser module 4 will be described later.

The optical components 5 are components that optically process the laser light La emitted from the laser module 4. In the present embodiment, the optical components 5 include a collimator lens 5a, a slit 5b, and a neutral density filter 5c. The collimator lens 5a, the slit 5b, and the neutral density filter 5c are arranged in this order along the optical path of the laser light La. The optical components 5 may have other configurations.

The movable mirror 6 is a member for performing scanning with the laser light Ls. The movable mirror 6 is provided in a direction in which the laser light La processed by the optical components 5 is emitted. The movable mirror 6 is swingable about an axis extending in the horizontal direction of the lens 3 and about an axis extending in the vertical direction of the lens 3, for example, and reflects the laser light La to emit the reflected light Ls while changing the angle in the horizontal direction and the vertical direction. As the movable mirror 6, for example, a micro electro mechanical systems (MEMS) mirror is used.

The laser driver 7 is a driving circuit for driving the laser module 4. The laser driver 7 drives the laser module 4 based on, for example, the optical intensity of the laser light La and the temperatures of the laser light sources 411, 412, and 413 included in the laser module 4. The mirror driver 8 is a driving circuit for driving the movable mirror 6. The mirror driver 8 swings the movable mirror 6 within a predetermined angle range and at a predetermined timing. The controller 9 is a device for controlling the laser driver 7 and the mirror driver 8.

In the optical engine 20, the laser light La having a color and optical intensity corresponding to a pixel of an image to be projected onto the retina is emitted from the laser module 4, passes through the optical components 5, and is reflected by the movable mirror 6. The laser light La reflected by the movable mirror 6 is emitted to the reflector 30 as the laser light Ls.

The reflector 30 is a member that projects an image onto the retina of the user wearing the near-eye wearable device 1 by reflecting the laser light Ls having passed through the movable mirror 6 and guiding reflected light Lrf to the retina.

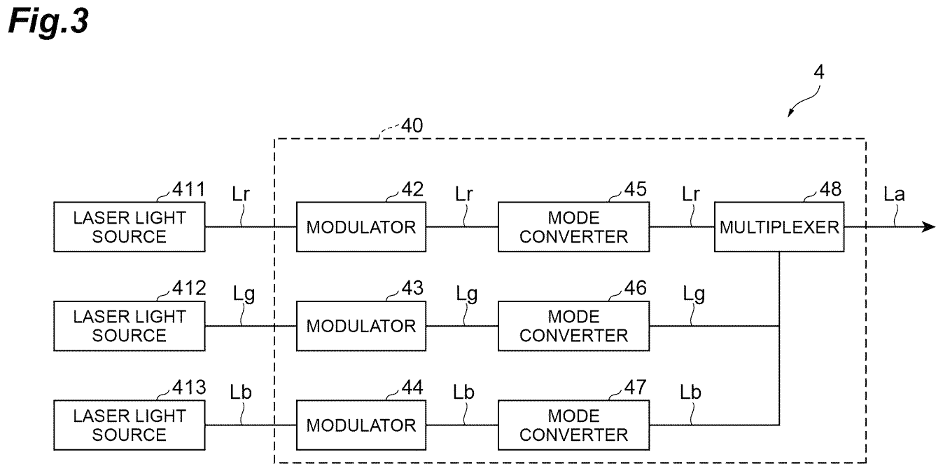

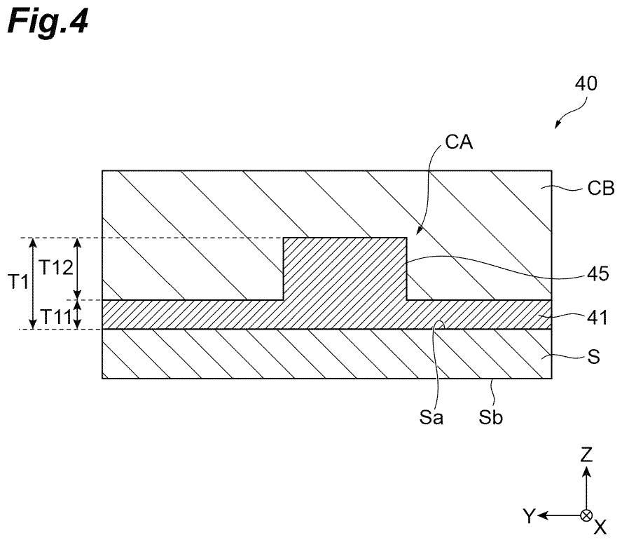

Next, a configuration of the laser module 4 will be described with reference to FIGS. 3 and 4. FIG. 3 is a block diagram of a laser module illustrated in FIG. 2. FIG. 4 is a diagram illustrating a cross-sectional configuration of an optical element illustrated in FIG. 3.

As illustrated in FIG. 3, the laser module 4 includes an optical element 40, a laser light source 411 (first laser light source) that emits red light Lr, a laser light source 412 (second laser light source) that emits green light Lg, and a laser light source 413 (third laser light source) that emits blue light Lb. The laser light source 411 is, for example, a red laser diode. The laser light source 412 is, for example, a green laser diode. The laser light source 413 is, for example, a blue laser diode. A peak wavelength of the red light Lr is, for example, in a range of 600 nm to 830 nm. A peak wavelength of the green light Lg is, for example, in a range of 500 nm to 570 nm. A peak wavelength of the blue light Lb is, for example, in a range of 380 nm to 490 nm.

In the present embodiment, the laser light source 411 emits the red light Lr in a TM0 mode. The laser light source 412 emits the green light Lg in the TM0 mode. The laser light source 413 emits the blue light Lb in the TM0 mode. Since the red light Lr, the green light Lg, and the blue light Lb are all visible light, in the following description, the red light Lr, the green light Lg, and the blue light Lb may be referred to as each visible light, and the red light Lr, the green light Lg, and the blue light Lb may be collectively referred to as visible light.

The optical element 40 multiplexes the visible light emitted from each laser light source into one laser light La. The optical element 40 is, for example, a planar lightwave circuit (PLC). As illustrated in FIG. 4, the optical element 40 includes a substrate S, a core layer CA, and a cladding layer CB.

The substrate S functions as a lower cladding layer. The substrate S consists of a material having a refractive index lower than that of a constituent material of the core layer CA. Examples of the constituent material of the substrate S include sapphire, silicon, and aluminum oxide (Al₂O₃). The substrate S includes a main surface Sa and a rear surface Sb opposite to the main surface Sa. The main surface Sa and the rear surface Sb are surfaces defined by the X-axis direction and the Y-axis direction, and intersect the Z-axis direction. In this embodiment, the main surface Sa and the rear surface Sb are orthogonal to the Z-axis direction. In other words, the X-axis direction and the Y-axis direction are directions along the main surface Sa.

The cladding layer CB functions as an upper cladding layer. The cladding layer CB covers the core layer CA on the main surface Sa. The cladding layer CB consists of a material having a refractive index lower than that of a constituent material of the core layer CA. Examples of the constituent material of the cladding layer CB include silicon oxide (for example, SiO₂).

The core layer CA is provided on the main surface Sa. The core layer CA consists of a material having an electro-optical effect. The electro-optical effect is a phenomenon in which a refractive index of a material varies when applying an electric field to the material. Examples of the constituent material of the core layer CA include lithium niobate (LiNbO₃). In this embodiment, the core layer CA is a lithium niobate thin film formed on the main surface Sa of the substrate S by sputtering, and an optical axis (C-axis) of lithium niobate extends in the Z-axis direction. The core layer CA may consist of Z-cut lithium niobate.

The core layer CA includes a slab 41, a modulator 42 (first modulator), a modulator 43 (second modulator), a modulator 44 (third modulator), a mode converter 45 (first mode converter), a mode converter 46 (second mode converter), a mode converter 47 (third mode converter), and a multiplexer 48.

As illustrated in FIG. 4, the slab 41 is provided on the main surface Sa. The slab 41 has a flat plate shape. A length of the slab 41 in the Z-axis direction is a height T11. Hereinafter, the length in the Z-axis direction may be referred to as “height”. The height T11 is, for example, 0.1 μm to 0.7 μm.

In this embodiment, the modulators 42, 43, and 44, the mode converters 45, 46, and 47, and the multiplexer 48 are provided on one slab 41. Only the mode converters 45, 46, and 47 may be provided on the one slab 41. That is, the modulators 42, 43, and 44 and the multiplexer 48 may not be provided on the slab 41. The slab 41 may be provided for each mode converter.

The modulator 42 is a modulator that modulates the optical intensity of the red light Lr. The red light Lr in the TM0 mode is incident to an incident end of the modulator 42 from the laser light source 411. The modulator 42 modulates the optical intensity of the red light Lr in the TM0 mode incident from the laser light source 411. An emission end of the modulator 42 is optically connected to an incident end of the mode converter 45.

The modulator 43 is a modulator that modulates the optical intensity of the green light Lg. The green light Lg in the TM0 mode is incident to an incident end of the modulator 43 from the laser light source 412. The modulator 43 modulates the optical intensity of the green light Lg in the TM0 mode incident from the laser light source 412. An emission end of the modulator 43 is optically connected to an incident end of the mode converter 46.

The modulator 44 is a modulator that modulates the optical intensity of the blue light Lb. The blue light Lb in the TM0 mode is incident to an incident end of the modulator 44 from the laser light source 413. The modulator 44 modulates the optical intensity of the blue light Lb in the TM0 mode incident from the laser light source 413. An emission end of the modulator 44 is optically connected to an incident end of the mode converter 47. Each of the modulators is, for example, a Mach-Zehnder modulator.

The mode converter 45 is a mode converter that converts a polarization mode of the red light Lr from the TM0 mode to the TE0 mode. The red light Lr whose optical intensity has been modulated by the modulator 42 is incident to the incident end of the mode converter 45. The mode converter 46 is a mode converter that converts a polarization mode of the green light Lg from the TM0 mode to the TE0 mode. The green light Lg whose optical intensity has been modulated by the modulator 43 is incident to the incident end of the mode converter 46. The mode converter 47 is a mode converter that converts a polarization mode of the blue light Lb from the TM0 mode to the TE0 mode. The blue light Lb whose optical intensity has been modulated by the modulator 44 is incident to the incident end of the mode converter 47. An emission end of the mode converter 45, an emission end of the mode converter 46, and an emission end of the mode converter 47 are optically connected to three incident ends of the multiplexer 48, respectively.

Each of the mode converter 45, the mode converter 46, and the mode converter 47 extends in the X-axis direction. The mode converter 45, the mode converter 46, and the mode converter 47 are arranged in this order in the Y-axis direction.

A height of the mode converter 45, a height of the mode converter 46, and a height of the mode converter 47 are substantially the same as each other, and are a height T12. The height T12 is, for example, 0.1 μm to 0.7 μm. A height of the core layer CA is the sum of the height T11 and the height T12, and is a height T1. The height T1 is smaller than a wavelength of visible light to be converted. The height T1 is, for example, 0.2 μm to 0.8 μm. The height of the mode converter 45, the height of the mode converter 46, and the height of the mode converter 47 may be different from each other. A detailed configuration of each mode converter will be described later.

In a case where the slab 41 is provided for each mode converter, the height T1 only needs to be smaller than a wavelength of visible light to be converted in a corresponding mode converter. In a combination of the slab 41 and the mode converter 45, the height T1 only needs to be smaller than a wavelength of the red light Lr. In a combination of the slab 41 and the mode converter 46, the height T1 only needs to be smaller than a wavelength of the green light Lg. In a combination of the slab 41 and the mode converter 47, the height T1 only needs to be smaller than a wavelength of the blue light Lb.

The multiplexer 48 multiplexes the red light Lr, the green light Lg, and the blue light Lb whose polarization modes have been converted in the respective mode converters into one visible light. The three incident ends of the multiplexer 48 are optically connected to the emission end of the mode converter 45, the emission end of the mode converter 46, and the emission end of the mode converter 47, respectively. The multiplexer 48 emits the multiplexed visible light as the laser light La from the emission end of the multiplexer 48.

In the laser module 4, the visible light in the TM0 mode is emitted from each laser light source, and the optical intensity of each visible light is modulated in each modulator. Thereafter, the polarization mode of the visible light is converted from the TM0 mode to the TE0 mode in each mode converter. Then, each visible light of which the polarization mode is converted is multiplexed in the multiplexer 48 to be emitted from the multiplexer 48 to the optical components 5 (refer to FIG. 2) as the laser light La in the TE0 mode.

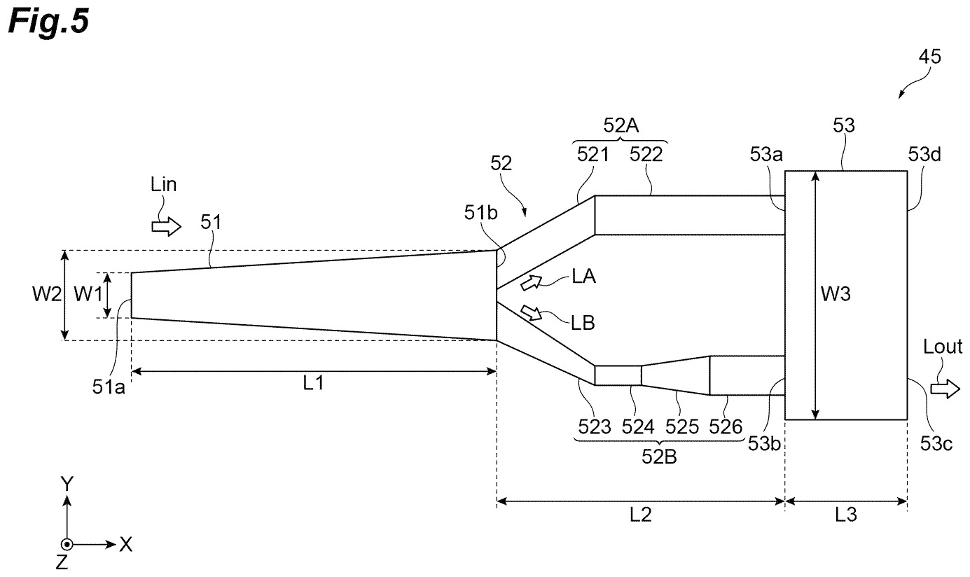

Next, specific configurations of the mode converter 45, the mode converter 46, and the mode converter 47 will be described with reference to FIGS. 4 and 5. FIG. 5 is a plan view illustrating a configuration of a mode converter illustrated in FIG. 3. As illustrated in FIG. 5, each of the mode converter 45, the mode converter 46, and the mode converter 47 includes a conversion unit 51, a splitting unit 52, and a multiplexing unit 53. Since the configurations of the mode converter 45, the mode converter 46, and the mode converter 47 are the same as each other, the mode converter 45 will be exemplified here.

The conversion unit 51 is a portion that converts the polarization mode of the visible light from the TM0 mode to the TE1 mode. As illustrated in FIG. 5, the conversion unit 51 is located at one end of the mode converter 45 in the X-axis direction. The conversion unit 51 includes an incident end 51a (first end) and an emission end 51b (second end) which are both ends in the X-axis direction. The red light in the TM0 mode is incident to the incident end 51a from the laser light source 411. Hereinafter, the red light incident to the incident end 51a may be referred to as “light Lin”. The emission end 51b emits the light Lin in the TE1 mode. The emission end 51b emits the light Lin in the TE1 mode to the splitting unit 52. A length L1 of the conversion unit 51 in the X-axis direction is, for example, 10 μm to 10,000 μm.

A length of the conversion unit 51 in the Y-axis direction continuously increases from the incident end 51a to the emission end 51b. Hereinafter, the length in the Y-axis direction may be referred to as a “width”. The width of the conversion unit 51 continuously increases from a width W1 to a width W2 from the incident end 51a toward the emission end 51b. The width W1 is smaller than the width W2. The width W1 is, for example, 0.3 μm to 1.0 μm. The width W2 is, for example, 0.4 μm to 1.2 μm. An increase rate of the width of the conversion unit 51 may be constant.

In the conversion unit 51, an effective refractive index of the TM0 mode and an effective refractive index of the TE1 mode approach each other and then intersect with each other as being spaced apart from the incident end 51a in the X-axis direction, and thus conversion between the TM0 mode and the TE1 mode is induced. Therefore, when the light Lin in the TM0 mode is incident to the incident end 51a, the polarization mode of the light Lin is converted from the TM0 mode to the TE1 mode in the conversion unit 51. On the other hand, an effective refractive index of the TE0 mode is sufficiently separated from the effective refractive index of the TM0 mode and the effective refractive index of the TE1 mode over the entire length of the conversion unit 51 in the X-axis direction. Therefore, when the light Lin in the TE0 mode is incident to the incident end 51a, the polarization mode of the light Lin is maintained in the TE0 mode.

The splitting unit 52 splits the light Lin in the TE1 mode incident from the emission end 51b of the conversion unit 51 into a split light LA (first split light) in the TE0 mode and a split light LB (second split light) in the TE0 mode, and adjusts a phase difference Δφ between the split light LA and the split light LB. The phase difference Δφ is a phase difference obtained by subtracting a phase of the split light LA when incident to the multiplexing unit 53 from a phase of the split light LB when incident to the multiplexing unit 53. The splitting unit 52 splits the light Lin in the TE1 mode into the split light LA in the TE0 mode and the split light LB in the TE0 mode having phases opposite to each other. An optical intensity of the split light LA and an optical intensity of the split light LB are substantially the half (50%) of an optical intensity of the light Lin in the TE1 mode incident from the emission end 51b. In this embodiment, the splitting unit 52 includes a Y-branch waveguide. A length L2 of the splitting unit 52 in the X-axis direction is, for example, 10 μm to 1000 μm. The splitting unit 52 includes a branch waveguide 52A (first branch wave guide) and a branch wave guide 52B (second branch wave guide).

The branch wave guide 52A is a waveguide through which the split light LA propagates. The branch wave guide 52A is disposed between the conversion unit 51 and the multiplexing unit 53, and includes a connection end (an end 521a to be described later) connected to the conversion unit 51 and a connection end (an end 522b to be described later) connected to the multiplexing unit 53. The branch wave guide 52A emits the split light LA in the TE0 mode split from the light Lin in the TE1 mode to the multiplexing unit 53.

The branch wave guide 52B is a waveguide through which the split light LB propagates. The branch wave guide 52B is disposed between the conversion unit 51 and the multiplexing unit 53, and includes a connection end (an end 523a to be described later) connected to the conversion unit 51 and a connection end (an end 526b to be described later) connected to the multiplexing unit 53. The branch wave guide 52B emits the split light LB in the TE0 mode split from the light Lin in the TE1 mode to the multiplexing unit 53.

The branch wave guide 52A and the branch wave guide 52B extend in the X-axis direction so as to be separated from each other in the Y-axis direction as being spaced apart from the conversion unit 51, and then extend substantially parallel to each other to the multiplexing unit 53.

The multiplexing unit 53 multiplexes the split light LA and the split light LB. The multiplexing unit 53 multiplexes the split light LA incident from the branch wave guide 52A and the split light LB incident from the branch wave guide 52B to emit the red light in the TE0 mode. Hereinafter, the red light emitted from the multiplexing unit 53 may be referred to as “light Lout”. When the multiplexing unit 53 emits the light Lout, an optical intensity of the light Lout varies depending on the phase difference Δφ. For example, in a case where the phase difference Δφ is −π/2 radians, the optical intensity of the light Lout is substantially the same (100%) as the optical intensity of the light Lin in the TE1 mode emitted from the emission end 51b. Note that, the phase difference Δφ will be described later.

In this embodiment, the multiplexing unit 53 includes a multimode interferometer. Specifically, the multiplexing unit 53 includes a two-input two-output multimode interferometer. That is, the multiplexing unit 53 includes an incident end 53a, an incident end 53b, an emission end 53c, and an emission end 53d. A connection end (the end 522b to be described later) of the branch wave guide 52A is connected to the incident end 53a. A connection end (the end 526b to be described later) of the branch wave guide 52B is connected to the incident end 53b. In this embodiment, since the mode converter 45 is used as a mode converter that converts the polarization mode of the red light Lr from the TM0 mode to the TE0 mode, the emission end 53c is connected to the incident end of the multiplexer 48 and emits the light Lout in the TE0 mode. A length L3 of the multiplexing unit 53 in the X-axis direction is, for example, 2.0 μm to 1000 μm. A width W3 of the multiplexing unit 53 is, for example, 1.0 μm to 10 μm.

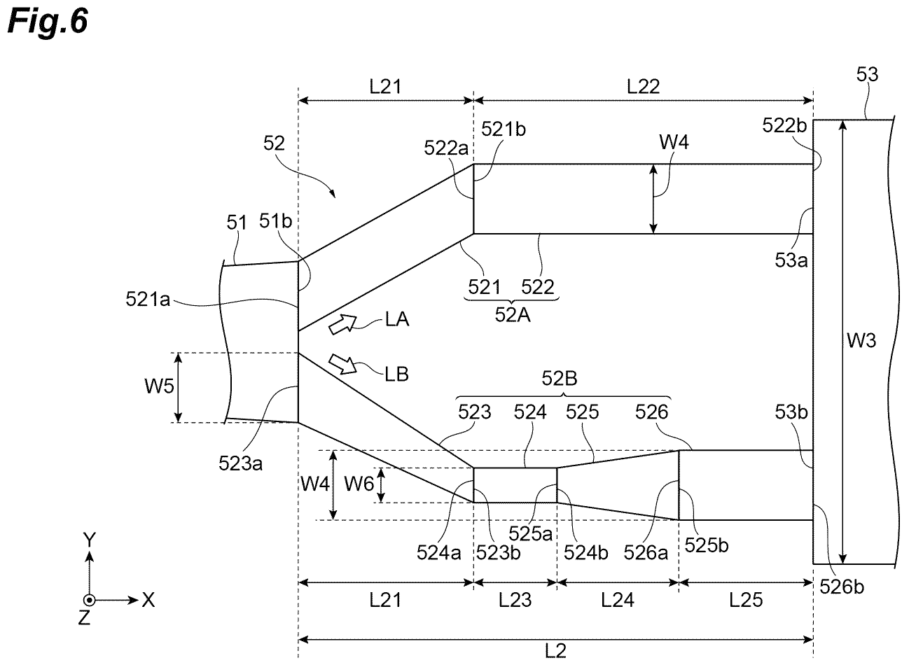

Next, a configuration of the splitting unit 52 will be described in more detail with reference to FIGS. 5 and 6. FIG. 6 is an enlarged plan view illustrating a splitting unit illustrated in FIG. 5. In the splitting unit 52, an optical path length OL1 of the split light LA in the branch wave guide 52A and an optical path length OL2 of the split light LB in the branch wave guide 52B are different from each other. In this embodiment, a physical length of the branch wave guide 52A along the optical path of the split light LA is equal to a physical length of the branch wave guide 52B along the optical path of the split light LB. A width of the branch wave guide 52A is constant over the entire length of the branch wave guide 52A, whereas a width of the branch wave guide 52B is smaller than the width of the branch wave guide 52A at a part of the branch wave guide 52B. Hereinafter, a specific description will be given.

The branch wave guide 52A includes a waveguide 521 and a waveguide 522. The waveguide 521 and the waveguide 522 are arranged in this order in the X-axis direction. In this embodiment, the waveguide 521 extends obliquely with respect to the X-axis direction, and the waveguide 522 extends substantially parallel to the X-axis direction.

The waveguide 521 includes the end 521a and an end 521b which are both ends in the X-axis direction. The waveguide 522 includes an end 522a and the end 522b which are both ends in the X-axis direction. The end 521a is connected to the emission end 51b. The end 521b and the end 522a are connected to each other. The end 522b is connected to the incident end 53a. As described above, in this embodiment, the branch wave guide 52A is configured by connecting the waveguide 521 and the waveguide 522. In this embodiment, the end 521a is a connection end connected to the conversion unit 51 of the branch wave guide 52A, and the end 522b is a connection end connected to the multiplexing unit 53 of the branch wave guide 52A.

A width of the waveguide 521 at the end 521a is, for example, 50% or less of the width W2, and is smaller than 50% of the width W2 in this embodiment. The width of the waveguide 521 is substantially constant at a width W4 between the ends 521a and 521b. The width of the waveguide 522 is substantially constant at the width W4 between the ends 522a and 522b. Therefore, in this embodiment, the width W4 is also smaller than 50% of the width W2. Furthermore, in this embodiment, the width W4 is 23% to 47% of the width W3. Therefore, the width of the waveguide 522 (branch wave guide 52A) at the end 522b is also 23% to 47% of the width W3. The width W4 is, for example, 0.4 μm to 4.0 μm.

A length L21 of the waveguide 521 in the X-axis direction is, for example, 1.0 μm to 100 μm. A length L22 of the waveguide 522 in the X-axis direction is, for example, 1.0 μm to 300 μm. In this embodiment, the sum of the length L21 and the length L22 is the length L2.

The branch wave guide 52B includes a waveguide 523, a waveguide 524, a waveguide 525, and a waveguide 526. The waveguide 523, the waveguide 524, the waveguide 525, and the waveguide 526 are arranged in this order in the X-axis direction. In this embodiment, the waveguide 523 extends obliquely with respect to the X-axis direction, and the waveguide 524, the waveguide 525, and the waveguide 526 extend substantially parallel to the X-axis direction. The waveguide 521 and the waveguide 523 are inclined so as to be separated from each other in the Y-axis direction as being spaced apart from the emission end 51b.

The waveguide 523 includes the end 523a and an end 523b which are both ends in the X-axis direction. The waveguide 524 includes an end 524a and an end 524b which are both ends in the X-axis direction. The waveguide 525 includes an end 525a and an end 525b which are both ends in the X-axis direction. The waveguide 526 includes an end 526a and the end 526b which are both ends in the X-axis direction. The end 523a is connected to the emission end 51b. The end 523b and the end 524a are connected to each other. The end 524b and the end 525a are connected to each other. The end 525b and the end 526a are connected to each other. The end 526b is connected to the incident end 53b. As described above, in this embodiment, the branch wave guide 52B is configured by connecting the waveguide 523, the waveguide 524, the waveguide 525, and the waveguide 526. In this embodiment, the end 523a is a connection end connected to the conversion unit 51 of the branch wave guide 52B, and the end 526b is a connection end connected to the multiplexing unit 53 of the branch wave guide 52B.

A width of the waveguide 523 continuously decreases from the end 523a to the end 523b. The width of the waveguide 523 decreases from a width W5 to a width W6 from the end 523a toward the end 523b. The width W5 is, for example, 50% or less of the width W2, and is smaller than 50% of the width W2 in this embodiment. The width W5 may be substantially the same as the width of the waveguide 521 at the end 521a, and may be different from the width of the waveguide 521 at the end 521a. In this embodiment, the width W5 is substantially the same as the width W4, and the width W6 is smaller than the width W2 and the width W5. The width W6 may be larger than the width W5. The width W6 may be larger than the width W2. The width W6 is, for example, 0.2 μm to 3.0 μm. The width of the waveguide 524 is substantially constant at the width W6 between the ends 524a and 524b.

A width of the waveguide 525 continuously increases from the end 525a to the end 525b. The width of the waveguide 525 increases from the width W6 to the width W4 from the end 525a toward the end 525b. A width of the waveguide 526 is substantially constant at the width W4 between the ends 526a and 526b. As described above, since the width W4 is 23% to 47% of the width W3, the width of the waveguide 526 (branch wave guide 52B) at the end 526b is also 23% to 47% of the width W3. Note that, the width of the waveguide 526 at the end 526b may be different from the width of the waveguide 522 at the end 522b.

A length of the waveguide 523 in the X-axis direction is the length L21. A length L23 of the waveguide 524 in the X-axis direction is, for example, 0 μm to 100 μm. A length L24 of the waveguide 525 in the X-axis direction is, for example, 1.0 μm to 100 μm. A length L25 of the waveguide 526 in the X-axis direction is, for example, 0 μm to 100 μm. In this embodiment, the sum of the length L21, the length L23, the length L24, and the length L25 is the length L2.

Next, an optical path length difference ΔOL and the phase difference Δφ between the optical path length OL1 and the optical path length OL2 will be described. Hereinafter, a wavelength of the split light LA and a wavelength of the split light LB are referred to as a wavelength λ, an effective refractive index of the split light LA is referred to as an effective refractive index n_{effA}, and an effective refractive index of the split light LB is referred to as an effective refractive index n_{effB}(s). Since the width of the branch wave guide 52A is constant over the entire length of the branch wave guide 52A, the effective refractive index n_{effA} is constant over the entire length of the branch wave guide 52A. Since the width of the branch wave guide 52B is not constant over the entire length of the branch wave guide 52B, the effective refractive index n_{effB}(s) is expressed as a function of a position s along the optical path of the split light LB. Here, for convenience of description, the position s at the end 523a is set to 0.

First, the optical path length difference ΔOL will be described. In this embodiment, an optical path length difference obtained by subtracting the optical path length OL1 from the optical path length OL2 is defined as the optical path length difference ΔOL (=OL2−OL1). As described above, in the waveguide 523 and the waveguide 525 whose widths vary, the split light LB propagates through the waveguide 523 and the waveguide 525 while changing its effective refractive index. Further, except for the ends 523a and 525b, the width of the waveguide 523, the width of the waveguide 524, and the width of the waveguide 525 are smaller than the width of the waveguides 521 and 522. Therefore, in the waveguides 523, 524, and 525 excluding the end 523a and the end 525b, a relationship of the effective refractive index n_{effB}(s)<the effective refractive index n_{effA} is established.

Furthermore, the optical path length OL1 is expressed by Equation (1) by using the physical length PL2 of the branch wave guide 52A along the optical path of the split light LA and the effective refractive index n_{effA}.

$$\begin{matrix}[ Equation 1 ] & \\ OL 1 = {n}_{effA} \times PL 2 & ( 1 )\end{matrix}$$

The optical path length OL2 is expressed by Equation (2) by using the effective refractive index n_{effB}(s). Note that, the physical length of the branch wave guide 52B along the optical path of the split light LB is the same as the physical length of the branch wave guide 52A along the optical path of the split light LA, and is the length PL2.

$$\begin{matrix}[ Equation 2 ] & \\ OL 2 = {\int }_{0}^{PL 2} {n}_{effB} ( s ) ds & ( 2 )\end{matrix}$$

As described above, in the waveguides 523, 524, and 525 excluding the end 523a and the end 525b, the relationship of the effective refractive index n_{effB}(s)<the effective refractive index n_{effA} is established, and thus the optical path length difference ΔOL is a negative value. From the above, in the branch wave guide 52B, the optical path length difference ΔOL occurs between the optical path length OL1 and the optical path length OL2 by adopting a configuration in which the width of the waveguide 523 and the width of the waveguide 525 vary.

Next, the phase difference Δφ will be described. In this embodiment, a phase difference obtained by subtracting the phase of the split light LA when incident to the splitting unit 52 from a phase of the split light LB when incident to the splitting unit 52 is defined as an initial phase difference Δφ₀. In a case where the light Lin in the TM0 mode is incident to the mode converter 45, since the phase of the split light LB when being incident to the splitting unit 52 is delayed by π radians from the phase of the split light LA when being incident to the splitting unit 52, the initial phase difference Δφ₀ is −π radians. In a case where the light Lin in the TE0 mode is incident to the mode converter 45, the initial phase difference Δφ₀ is 0 radians.

As described above, in the splitting unit 52, the optical path length difference ΔOL is a negative value. As a result, the phase difference Δφ is changed from the initial phase difference Δφ₀. Here, a relationship between the phase difference Δφ and the optical path length difference ΔOL is expressed as ΔOL=(Δφ₀−Δφ)×(λ/2π radians) by using the wavelength λ. In the multiplexing unit 53, the phase difference Δφ that maximizes the optical intensity of the light Lout, that is, the phase difference Δφ that maximizes the conversion efficiency from the TM0 mode to the TE0 mode is −π/2+2nπ radians (n is an integer). Therefore, from the above relationship, the optical path length difference ΔOL that maximizes the conversion efficiency is −λ/4+nλ. Note that, the conversion efficiency represents a ratio of the optical intensity of the visible light in the TE0 mode emitted from the mode converter 45 to the optical intensity of the visible light in the TM0 mode incident to the mode converter 45.

In this embodiment, the phase difference Δφ is set so that the conversion efficiency becomes 86.6% or more. Therefore, the phase difference Δφ is set within a range of −2π/3+2nπ radians to −π/3+2nπ radians, and the optical path length difference ΔOL is set within a range of −π/3+nλ to −λ/6+nλ. That is, the splitting unit 52 adjusts the phase difference Δφ so that the phase difference Δφ falls within the range of −2π/3+2nπ radians to −π/3+2nπ radians. In this embodiment, the lengths of the waveguides 524, 525, and 526 in the X-axis direction and the width W6 are set so that the optical path length difference ΔOL falls within the range of −λ/3+nλ to −λ/6+nλ.

In this embodiment, the light Lin in the TM0 mode is incident to the mode converter 45. In this case, in the conversion unit 51, the polarization mode of the light Lin is converted from the TM0 mode into the TE1 mode, and the light Lin in the TE1 mode is emitted from the emission end 51b to the splitting unit 52. Then, in the splitting unit 52, the light Lin in the TE1 mode is split into the split light LA in the TE0 mode and the split light LB in the TE0 mode having phases opposite to each other. Then, the split light LA propagates through the branch wave guide 52A, and the split light LB propagates through the branch wave guide 52B. The optical intensity of the split light LA and the optical intensity of the split light LB are substantially the half of the optical intensity of the light Lin.

For example, when the optical path length OL1 of the branch wave guide 52A and the optical path length OL2 of the branch wave guide 52B are the same as each other, the split light LA and the split light LB are incident to the multiplexing unit 53 without changing the phase difference Δφ from −π radians (initial phase difference Δφ₀). In this case, the light Lout in the TE0 mode having phases opposite to each other is emitted from the emission end 53c and the emission end 53d. The optical intensity of the light Lout emitted from the emission end 53c and the optical intensity of the light Lout emitted from the emission end 53d are substantially the half of the optical intensity of the light Lin.

On the other hand, in this embodiment, since the optical path length OL1 of the branch wave guide 52A and the optical path length OL2 of the branch wave guide 52B are different from each other, the phase difference Δφ is a value different from −π radians. For example, in a case where the phase difference Δφ is −π/2 radians, the multiplexing unit 53 multiplexes the split light LA and the split light LB, and thus the light Lout in the TE0 mode is emitted from the emission end 53c. The optical intensity of the light Lout emitted from the emission end 53c is substantially the same as the optical intensity of the light Lin.

In a case where the light Lin in the TE0 mode is incident to the mode converter 45, the polarization mode of the light Lin is not converted in the conversion unit 51, and the light Lin in the TE0 mode is emitted from the emission end 51b to the splitting unit 52. Then, in the splitting unit 52, the light Lin in the TE0 mode is split into the split light LA in the TE0 mode and the split light LB in the TE0 mode having the same phase. Then, the split light LA propagates through the branch wave guide 52A, and the split light LB propagates through the branch wave guide 52B. The optical intensity of the split light LA and the optical intensity of the split light LB are substantially the half of the optical intensity of the light Lin. At this time, since the optical path length OL1 of the branch wave guide 52A and the optical path length OL2 of the branch wave guide 52B are different from each other, the phase difference Δφ has a value different from 0 radians (initial phase difference Δφ₀). For example, in a case where the phase difference Δφ is π/2 radians, the multiplexing unit 53 multiplexes the split light LA and the split light LB, and thus the light Lout in the TE0 mode is emitted from the emission end 53d. The optical intensity of the light Lout emitted from the emission end 53d is substantially the same as the optical intensity of the light Lin.

In the laser module 4 and the optical element 40 described above, since the width of the conversion unit 51 continuously increases from the incident end 51a to the emission end 51b, the effective refractive index of visible light propagating through the conversion unit 51 varies. As a result, in the conversion unit 51, the polarization mode of the visible light can be converted from the TM0 mode to the TE1 mode. Further, in the splitting unit 52, the visible light in the TE1 mode emitted from the conversion unit 51 is split into the split light LA and LB in the TE0 mode having phases opposite to each other. Then, the split light LA propagates through the branch wave guide 52A, and the split light LB propagates through the branch wave guide 52B. Then, the multiplexing unit 53 multiplexes the split light LA and the split light LB to emit visible light in the TE0 mode.

Here, in a case where the optical path length OL1 in the branch wave guide 52A and the optical path length OL2 in the branch wave guide 52B are the same as each other, the split light LA and the split light LB are incident to the multiplexing unit 53 without changing the phase difference Δφ from −π radians (initial phase difference Δφ₀). Therefore, the optical intensity of the visible light obtained by multiplexing the split light LA and the split light LB is substantially the half of the optical intensity of the visible light incident to the conversion unit 51, and the conversion efficiency decreases. On the other hand, in the laser module 4 and the optical element 40, since the optical path length OL1 and the optical path length OL2 are different from each other, the phase difference Δφ is a value different from −π radians. This makes it possible to suppress reduction of the optical intensity of the visible light obtained by multiplexing the split light LA and the split light LB from the optical intensity of the visible light incident to the conversion unit 51. As described above, the optical element 40 can convert the polarization mode of the visible light from the TM0 mode to the TE0 mode while suppressing a decrease in conversion efficiency.

When the phase difference Δφ is −π/2+2nπ radians, the optical intensity of the visible light in the TE0 mode obtained by multiplexing the split light LA and the split light LB is substantially the same as the optical intensity of the visible light in the TM0 mode incident to the conversion unit 51. As the phase difference Δφ separates from −π/2+2nπ radians, the optical intensity of the visible light in the TE0 mode obtained by multiplexing the split light LA and the split light LB decreases. In the optical element 40, the phase difference Δφ ranges from −2π/3+2nπ radians to −π/3+2nπ radians. Since this range is a range of ±π/6 centered at −π/2+2nπ radians, the loss of the optical intensity of the visible light in the TE0 mode obtained by multiplexing the split light LA and the split light LB can be further reduced. That is, it is possible to further suppress the decrease in conversion efficiency from the TM0 mode to the TE0 mode.

The mode converters 45, 46, and 47 are provided on the slab 41 in the Z-axis direction. According to this configuration, the waveguide formed by the conversion unit 51 and the slab 41 has an asymmetric shape in the Z-axis direction. Therefore, the conversion efficiency from the TM0 mode to the TE1 mode in the conversion unit 51 can be improved. Here, the asymmetry in the Z-axis direction represents that two portions separated by a symmetry plane, which passes through the center in the Z-axis direction of a portion obtained by combining the conversion unit 51 and the slab 41 and is orthogonal to the Z-axis direction, are not plane symmetric with respect to the symmetry plane. Furthermore, when the conversion efficiency from the TM0 mode to the TE1 mode in the conversion unit 51 is improved, the length L1 required to obtain the desired conversion efficiency can be shortened. Therefore, the optical element 40 can be downsized.

The height T1 of the core layer CA is smaller than the wavelength of visible light. According to this configuration, the visible light is likely to be leaked from the conversion unit 51 to the slab 41. As a result, the effect by the slab 41 can be exhibited in a satisfactory manner, and the conversion efficiency from the TM0 mode to the TE1 mode in the conversion unit 51 can be improved. Furthermore, when the conversion efficiency from the TM0 mode to the TE1 mode in the conversion unit 51 is improved, the length L1 required to obtain the desired conversion efficiency can be shortened. Therefore, the optical element 40 can be downsized.

The multiplexing unit 53 includes by the multimode interferometer. According to this configuration, the multiplexing unit 53 can be easily manufactured as compared with a case where the multiplexing unit 53 is manufactured by the Y-branch waveguide.

The width W3 of the multiplexing unit 53 is 2.0 μm or more. The magnitude of the width W3 may affect an interval between the branch wave guide 52A and the branch wave guide 52B. When the mode converters 45, 46, and 47 are manufactured, for example, anisotropic etching such as dry etching is used. At this time, in a case where the interval between the branch wave guide 52A and the branch wave guide 52B cannot be secured, a side surface of each waveguide is excessively scraped, and the branch wave guide 52A and the branch wave guide 52B may not be formed into desired shapes. On the other hand, in the laser module 4 and the optical element 40, since the width W3 of the multiplexing unit 53 is 2.0 μm or more, the interval between the branch wave guide 52A and the branch wave guide 52B can be secured without reducing the widths W4 of the branch wave guides 52A and 52B. Therefore, the branch wave guide 52A and the branch wave guide 52B can have desired shapes.

When the width W4 is less than 23% of the width W3, the tolerance of the mode converters 45, 46, and 47 with respect to a manufacturing error or the like becomes small. In addition, when the width W4 is larger than 47% of the width W3, there is a possibility that the interval between the branch wave guide 52A and the branch wave guide 52B cannot be sufficiently secured.

Here, a tolerance ΔL3 of the length L3 in the multiplexing unit 53 is expressed by Equation (3) by using a refractive index n_{f} of the constituent material of the core layer CA, a wavelength λ₀ of visible light to be converted by the mode converter including the multiplexing unit 53, and a Gaussian beam waist wo of the polarization mode of visible light.

$$\begin{matrix}[ Equation 3 ] & \\ Δ L 3 = π \times {n}_{r} \times \frac{{w}_{0}^{2}}{4 \times {λ}_{0}} & ( 3 )\end{matrix}$$

Further, a tolerance ΔW3 of the width W3 and a bandwidth Δλ₀ of the wavelength λ₀ corresponding to the tolerance ΔL3 are expressed by Equations (4) and (5), respectively.

$$\begin{matrix}[ Equation 4 ] & \\ Δ W 3 = W 3 \times \frac{Δ L 3}{2 \times L 3} & ( 4 )\end{matrix}$$

$$\begin{matrix}[ Equation 5 ] & \\ {Δλ}_{0} = {λ}_{0} \times \frac{Δ L 3}{L 3} & ( 5 )\end{matrix}$$

For example, when the Gaussian beam waist wo is 1000 nm, the refractive index n_{f} is 2.38, and the wavelength λ₀ is 638 nm, the tolerance ΔL3 is 2930 nm. Furthermore, in this case, if the length L3 is 64.5 μm and the width W3 is 3.0 μm, the tolerance ΔW3 is 68 nm, and the bandwidth Δλ₀ is 29 nm. Here, the width W3 is the largest of widths of all constituent elements of the mode converter. Therefore, the deviation tolerance Δw_{device}, which is a deviation tolerance of the width in the entire mode converters 45, 46, and 47, is equal to the tolerance ΔW3. Therefore, the deviation tolerance Δw_{device} in the entire mode converters 45, 46, and 47 having the bandwidth 4% of 29 nm is 68 nm.

The Gaussian beam waist wo is proportional to the width W4. For example, when the width W3 is 3.0 μm and the width W4 is 23% of the width W3, the width W4 is approximately 0.7 μm. In this case, the Gaussian beam waist wo is approximately 0.5 μm. Furthermore, in this case, if the refractive index nᵣ is 2.38, the wavelength λ is 638 nm, the length L3 is 64.5 μm, and the width W3 is 3.0 μm, the deviation tolerance Δw_{device} is approximately 34 nm. On the other hand, an interval of approximately 1.6 μm can be secured as the interval between the branch wave guide 52A and the branch wave guide 52B.

Furthermore, in a case where the width W3 is 3.0 μm and the width W4 is 47% of the width W3, the width W4 is approximately 1.4 μm. In this case, the Gaussian beam waist wo is approximately 1.0 μm. Furthermore, in this case, if the refractive index nᵣ is 2.38, the wavelength λ is 638 nm, the length L3 is 64.5 μm, and the width W3 is 3.0 μm, the deviation tolerance Δw_{device} is approximately 68 nm. On the other hand, an interval of approximately 0.2 μm can be secured as the interval between the branch wave guide 52A and the branch wave guide 52B.

Here, in a case where the width W4 is less than 23% of the width W3, the interval between the branch wave guide 52A and the branch wave guide 52B can be sufficiently secured, but the deviation tolerance Δw_{device} becomes small. In a case where the deviation tolerance Δw_{device} is small, the tolerance of the mode converters 45, 46, and 47 with respect to the manufacturing error and the like becomes small, and the degree of difficulty in manufacturing increases. On the other hand, in a case where the width W4 is larger than 47% of the width W3, the deviation tolerance Δw_{device} can be increased, but the interval between the branch wave guide 52A and the branch wave guide 52B cannot be sufficiently secured. In a case where the interval between the branch wave guide 52A and the branch wave guide 52B cannot be sufficiently secured, there is a possibility that the branch wave guide 52A and the branch wave guide 52B are not formed in desired shapes as described above. Therefore, by setting the width W4 to 23% or more and 47% or less of the width W3, both the tolerance of the mode converters 45, 46, and 47 with respect to the manufacturing error and the like and the interval between the branch wave guide 52A and the branch wave guide 52B can be secured.

The multiplexer 48 is designed so that multiplexing efficiency in a case of multiplexing the red light Lr, the green light Lg, and the blue light Lb in the TE0 mode becomes higher than multiplexing efficiency in a case of multiplexing the red light Lr, the green light Lg, and the blue light Lb in the TM0 mode. In the laser module 4 and the optical element 40, the mode converter 45 converts the polarization mode of the red light Lr from the TM0 mode to the TE0 mode, the mode converter 46 converts the polarization mode of the green light Lg from the TM0 mode to the TE0 mode, and the mode converter 47 converts the polarization mode of the blue light Lb from the TM0 mode to the TE0 mode. Accordingly, the multiplexing efficiency in the multiplexer 48 can be improved.

The height of the mode converter 45, the height of the mode converter 46, and the height of the mode converter 47 are the same as each other. According to this configuration, the mode converter 45, the mode converter 46, and the mode converter 47 can be formed on the same substrate S, and the heights of the respective mode converters can be made the same as each other, so that the optical element 40 can be easily manufactured.

In order to output full-color laser light La by multiplexing the red light Lr, the green light Lg, and the blue light Lb, it is necessary to adjust the optical intensity of light of each color in correspondence with an output color. In order to change the optical intensity of the light of the corresponding color in each laser light source, a large drive current is required. In the laser module 4 and the optical element 40, the optical intensity of the red light Lr is modulated by the modulator 42, the optical intensity of the green light Lg is modulated by the modulator 43, and the optical intensity of the blue light Lb is modulated by the modulator 44. This makes it possible to output the full-color laser light La without requiring a large drive current.

The near-eye wearable device 1 includes the retinal projection device 10, and the retinal projection device 10 includes the optical element 40. Therefore, in the near-eye wearable device 1 and the retinal projection device 10, it is possible to convert the polarization mode of the visible light from the TM0 mode to the TE0 mode and then project an image onto the retina while suppressing the decrease in conversion efficiency.

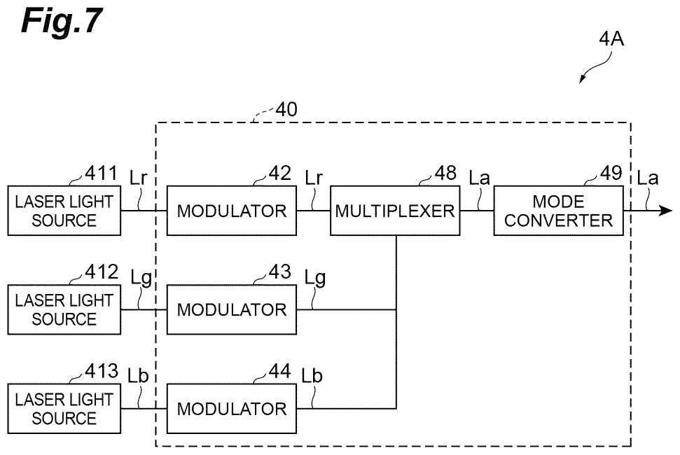

Next, a laser module according to another embodiment will be described with reference to FIG. 7. FIG. 7 is a block diagram of a laser module according to another embodiment. A laser module 4A illustrated in FIG. 7 is mainly different from the laser module 4 in that one mode converter 49 is included instead of the mode converter 45, the mode converter 46, and the mode converter 47, and that the multiplexer 48 is disposed between each modulator and the mode converter 49.

Specifically, the emission end of the modulator 42, the emission end of the modulator 43, and the emission end of the modulator 44 are optically connected to three incident ends of the multiplexer 48, respectively. The emission end of the multiplexer 48 is optically connected to an incident end of the mode converter 49. A configuration of the mode converter 49 is the same as the configuration of the mode converter 45.

In the laser module 4A, since the visible light in the TM0 mode is emitted from each laser light source, the optical intensity of the visible light in the TM0 mode is modulated in each modulator. Then, the visible light modulated by each modulator is multiplexed by multiplexer 48. Then, the polarization mode of the multiplexed visible light is converted from the TM0 mode to the TE0 mode in the mode converter 49, and the visible light is emitted from the mode converter 49 to the optical components 5 (refer to FIG. 2) as the laser light La in the TE0 mode.

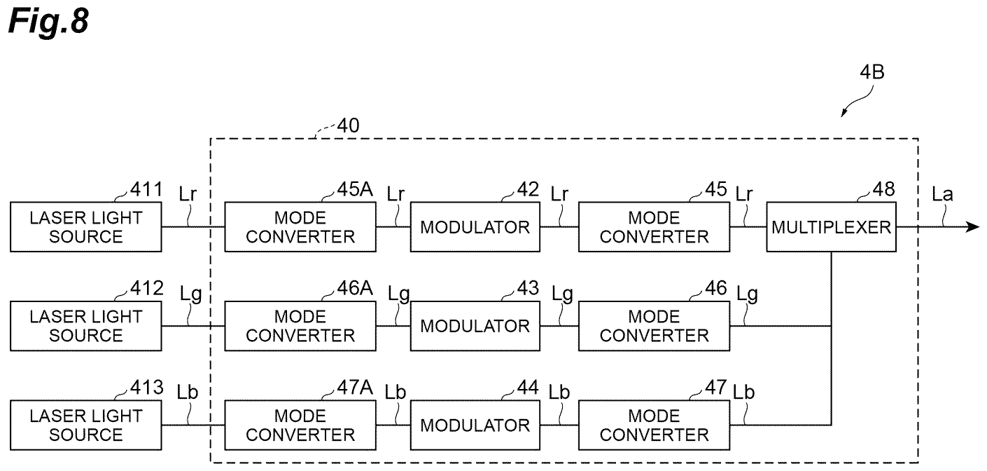

Next, a laser module according to still another embodiment will be described with reference to FIG. 8. FIG. 8 is a block diagram of a laser module according to still another embodiment. A laser module 4B illustrated in FIG. 8 is mainly different from the laser module 4 in a polarization mode of visible light emitted from the laser light sources 411, 412, and 413, and in that a mode converter 45A, a mode converter 46A, and a mode converter 47A are further included.

The laser light source 411 emits the red light Lr in the TE0 mode. The laser light source 412 emits the green light Lg in the TE0 mode. The laser light source 413 emits the blue light Lb in the TE0 mode.

The mode converter 45A is a mode converter that converts the polarization mode of the red light Lr from the TE0 mode to the TM0 mode. The mode converter 45A is provided between the laser light source 411 and the modulator 42. The red light Lr in the TE0 mode is incident to an incident end of the mode converter 45A from the laser light source 411, and an emission end of the mode converter 45A is optically connected to the incident end of the modulator 42. The mode converter 45A converts the polarization mode of the red light Lr incident from the laser light source 411 from the TE0 mode to the TM0 mode, and emits the red light Lr in the TM0 mode to the modulator 42.

In the mode converter 45A, for example, a configuration in which the incident end and the emission end of the mode converter 45 are exchanged is adopted. In this configuration, the red light Lr in the TE0 mode is incident to the emission end 53c of the multiplexing unit 53 from the laser light source 411, the incident end 53a of the multiplexing unit 53 emits the red light Lr in the TE0 mode to the branch wave guide 52A, and the incident end 53b of the multiplexing unit 53 emits the red light Lr in the TE0 mode to the branch wave guide 52B. A phase difference obtained by subtracting a phase of the red light Lr at the incident end 53a from a phase of the red light Lr at the incident end 53b is −π/2 radians.

Then, one red light Lr propagates through the branch wave guide 52A and is incident to the emission end 51b of the conversion unit 51. The other red light Lr propagates through the branch wave guide 52B and is incident to the emission end 51b of the conversion unit 51. The optical path length difference ΔOL between the optical path length OL1 in the branch wave guide 52A and the optical path length OL2 in the branch wave guide 52B is −λ/4+nλ. Therefore, the phase difference obtained by subtracting the phase of the one red light Lr at the emission end 51b from the phase of the other red light Lr at the emission end 51b is −π+2nπ radians. Therefore, at the emission end 51b, the two red lights Lr in the TE0 mode is combined to become the red light Lr in the TE1 mode, and the red light Lr in the TE1 mode propagates through the conversion unit 51 from the emission end 51b toward the incident end 51a. At this time, in the conversion unit 51, the polarization mode of the red light Lr is converted from the TE1 mode to the TM0 mode.

The mode converter 46A is a mode converter that converts the polarization mode of the green light Lg from the TE0 mode to the TM0 mode. The mode converter 46A is provided between the laser light source 412 and the modulator 43. The green light Lg in the TE0 mode is incident to an incident end of the mode converter 46A from the laser light source 412, and an emission end of the mode converter 46A is optically connected to the incident end of the modulator 43. The mode converter 46A converts the polarization mode of the green light Lg incident from the laser light source 412 from the TE0 mode to the TM0 mode, and emits the green light Lg in the TM0 mode to the modulator 43.

In the mode converter 46A, for example, a configuration in which the incident end and the emission end of the mode converter 46 are exchanged is also adopted. In this case, in the mode converter 46A, the polarization mode of the green light Lg is also converted from the TE0 mode to the TM0 mode in the same manner as the mode converter 45A.

The mode converter 47A is a mode converter that converts the polarization mode of the blue light Lb from the TE0 mode to the TM0 mode. The mode converter 47A is provided between the laser light source 413 and the modulator 44. The blue light Lb in the TE0 mode is incident to an incident end of the mode converter 47A from the laser light source 413, and an emission end of the mode converter 47A is optically connected to the incident end of the modulator 44. The mode converter 47A converts the polarization mode of the blue light Lb incident from the laser light source 413 from the TE0 mode to the TM0 mode, and emits the blue light Lb in the TM0 mode to the modulator 44.

In the mode converter 47A, for example, a configuration in which the incident end and the emission end of the mode converter 47 are exchanged is also adopted. In this case, in the mode converter 47A, the polarization mode of the blue light Lb is also converted from the TE0 mode to the TM0 mode in the same manner as the mode converter 45A.

In the laser module 4B, since the visible light in the TE0 mode is emitted from each laser light source, first, the polarization mode of each visible light emitted from each laser light source is converted from the TE0 mode to the TM0 mode in each of the mode converters 45A, 46A, and 47A. Then, after the optical intensity of the visible light in the TM0 mode is modulated in each modulator, the polarization mode of each modulated visible light is converted from the TM0 mode to the TE0 mode in each of the mode converters 45, 46, and 47. Then, each visible light is multiplexed in the multiplexer 48 to be emitted from the multiplexer 48 to the optical components 5 (refer to FIG. 2) as the laser light La in the TE0 mode.

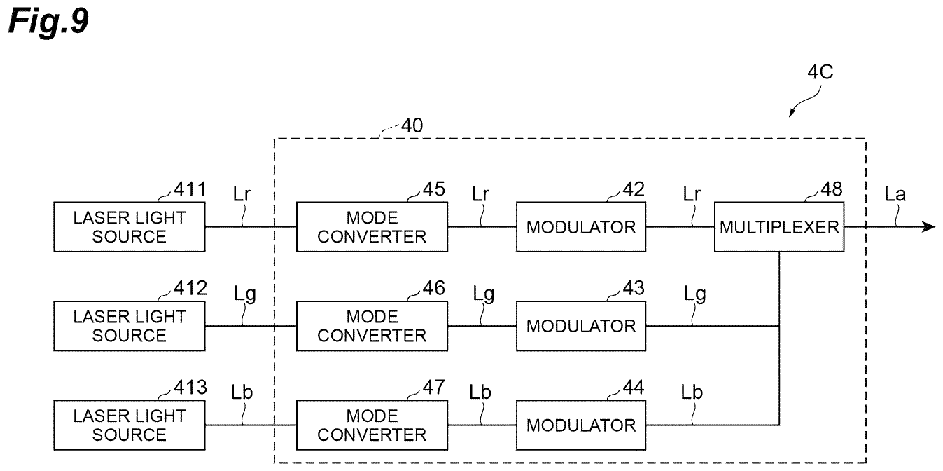

Next, a laser module according to still another embodiment will be described with reference to FIG. 9. FIG. 9 is a block diagram of a laser module according to still another embodiment. A laser module 4C is mainly different from the laser module 4 in that a direction of the C-axis of lithium niobate constituting the core layer CA and positions of the modulators 42, 43, and 44 and the mode converters 45, 46, and 47 are switched.

In this embodiment, the C-axis of lithium niobate extends in the Y-axis direction. The core layer CA consists of X-cut lithium niobate.

The red light Lr in the TM0 mode is incident to the incident end of the mode converter 45 from the laser light source 411, and the emission end of the mode converter 45 is optically connected to the incident end of the modulator 42. The mode converter 45 converts the polarization mode of the red light Lr incident from the laser light source 411 from the TM0 mode to the TE0 mode, and emits the red light Lr in the TE0 mode to the modulator 42.

The green light Lg in the TM0 mode is incident to the incident end of the mode converter 46 from the laser light source 412, and the emission end of the mode converter 46 is optically connected to the incident end of the modulator 43. The mode converter 46 converts the polarization mode of the green light Lg incident from the laser light source 412 from the TM0 mode to the TE0 mode, and emits the green light Lg in the TE0 mode to the modulator 43.

The blue light Lb in the TM0 mode is incident to the incident end of the mode converter 47 from the laser light source 413, and the emission end of the mode converter 47 is optically connected to the incident end of the modulator 44. The mode converter 47 converts the polarization mode of the blue light Lb incident from the laser light source 413 from the TM0 mode to the TE0 mode, and emits the blue light Lb in the TE0 mode to the modulator 44.

The emission end of the modulator 42, the emission end of the modulator 43, and the emission end of the modulator 44 are optically connected to the three incident ends of the multiplexer 48, respectively. As described above, the C-axis of lithium niobate extends in the Y-axis direction. Accordingly, the modulation efficiency of each modulator is improved in the TE mode.

In the laser module 4C, since the visible light in the TM0 mode is emitted from each laser light source, the polarization mode of each visible light emitted from each laser light source is converted from the TM0 mode to the TE0 mode in each mode converter. Then, after the optical intensity of the visible light in the TE0 mode is modulated in each modulator, each modulated visible light is multiplexed in the multiplexer 48 to be emitted from the multiplexer 48 to the optical components 5 (see FIG. 2) as the laser light La in the TE0 mode.

Although the embodiments of the present disclosure have been described above, the present disclosure is not necessarily limited to the above-described embodiments, and various modifications can be made without departing from the gist thereof.

For example, the laser module 4 may be applied to a device other than the near-eye wearable device 1.

The optical element 40 may not include the cladding layer CB. In this case, an air layer can function as the upper cladding layer.

The optical element 40 only needs to include at least one mode converter. In other words, the core layer CA only needs to include at least one mode converter that converts the polarization mode of the visible light from the TM0 mode to the TE0 mode.

The core layer CA may not include the slab 41. In this case, the mode converters 45, 46, and 47 may be directly provided on the main surface Sa of the substrate S.

The width of the conversion unit 51 only needs to increase continuously. The increase rate of the width of the conversion unit 51 may not be constant.

The configuration for adjusting the phase difference Δφ is not limited to the above-described configuration. For example, the phase difference Δφ may be adjusted by a difference in physical length between the branch wave guide 52A having a constant width over the entire length and the branch wave guide 52B having the same width as the width of the branch wave guide 52A over the entire length. For example, the physical length may be changed by providing a curved portion in one of the branch wave guide 52A and the branch wave guide 52B. The phase difference Δφ may be adjusted by changing both the waveguide width and the physical length of the waveguide between the branch wave guide 52A and the branch wave guide 52B. A configuration in which the width of the waveguide 523 continuously increases from the end 523a to the end 523b and the width of the waveguide 525 continuously decreases from the end 525a to the end 525b may be adopted. Further, the widths of the waveguides 521 and 522 may not be constant. For example, a configuration in which the width of the waveguide 521 continuously increases from the end 521a to the end 521b may be adopted, or a configuration in which the width of the waveguide 521 continuously decreases from the end 521a to the end 521b may be adopted. A configuration in which the width of the waveguide 522 continuously increases from the end 522a to the end 522b may be adopted, or a configuration in which the width of the waveguide 522 continuously decreases from the end 522a to the end 522b may be adopted.

Hereinafter, another example of a specific configuration of each waveguide in the splitting unit 52 will be described. In this another example, the width of the waveguide 521 may continuously increase from the end 521a to the end 521b. The width of the waveguide 521 may increase, for example, from 50% of the width W2 to the width W4 from the end 521a toward the end 521b. The width of the waveguide 522 may be substantially constant at the width W4 between the ends 522a and 522b. The width of the waveguide 523 may continuously increase from the width W5 to the width W6, for example, from the end 523a toward the end 523b. In this case, the width W5 may be 50% of the width W2. The width of the waveguide 524 may be substantially constant at the width W6 between the ends 524a and 524b. In this another example, the same configuration as the above-described embodiment may also be adopted in the waveguide 525 and the waveguide 526.

Alternatively, in still another example, in addition to the configuration of the above-described another example, a configuration in which the width of the waveguide 525 continuously decreases from the end 525a to the end 525b may be adopted. In this case, the width of the waveguide 525 may decrease from the width W6 to the width W4 from the end 525a toward the end 525b. That is, the width W6 may be larger than the width W4.

The multiplexing unit 53 may include the Y-branch waveguide or a directional coupler instead of the multimode interferometer.

### EXAMPLES

Hereinafter, in order to describe the above effect, the present disclosure will be described in more detail by way of examples. The present disclosure is not limited to these examples.

### <Evaluation of Relationship Between Length PL2 and Conversion Efficiency>

In the mode converters having the configurations of Examples 1 to 3, a relationship between the length PL2 and the conversion efficiency was evaluated. As the mode converters of Examples 1 to 3, a mode converter having the same configuration as the configuration illustrated in FIGS. 4 to 6 was used except that the configuration in which the width of the waveguide 521 increases from the end 521a toward the end 521b and the configuration in which the width of the waveguide 523 increases from the end 523a toward the end 523b were adopted. Further, in the mode converters of Examples 1 to 3, the width W5 was set to 50% of the width W2, and the width of the waveguide 521 at the end 521a was set to be substantially the same as the width W5. In Examples 1 to 3, while changing the length L24 of the waveguide 525 in the X-axis direction, the conversion efficiency at each length L24 in a case where the polarization mode of each of the red light, the green light, and the blue light was converted from the TM0 mode to the TE0 mode was calculated. In Examples 1 to 3, the length L22 of the waveguide 522 in the X-axis direction was also changed by the same amount as the length L24. That is, in Examples 1 to 3, the conversion efficiency at each length L24 was calculated in a state where the physical length of the branch wave guide 52A and the physical length of the branch wave guide 52B are the same as each other. Here, since the length PL2 is a physical length of the branch wave guide 52B along the optical path of the split light LB, the length PL2 varies by changing the length L24. Therefore, it can be said that the conversion efficiency calculated while changing the length L24 is the conversion efficiency calculated while changing the length PL2.

In Examples 1 to 3, as shown in Table 1, the height T1, the height T11, the length L1, the length L21, the length L22, the length L23, the length L25, the length L3, the width W1, the width W2, the width W3, the width W4, the width W5, and the width W6 were set for wavelengths of the respective colors.

TABLE 1

| | Example 1 | Example 2 | Example 3 |
|---|---|---|---|
| Color | R | G | B |
| Wavelength [nm] | 638 | 520 | 455 |
| T1 [μm] | 0.30 | 0.30 | 0.30 |
| T11 [μm] | 0.10 | 0.10 | 0.10 |
| L1 [μm] | 225 | 212 | 570 |
| L21 [μm] | 31.0 | 32.0 | 34.0 |
| L23 [μm] | 10.0 | 10.0 | 10.0 |
| L25 [μm] | 10.0 | 10.0 | 10.0 |
| L3 [μm] | 64.5 | 81.0 | 95.0 |
| W1 [μm] | 0.65 | 0.52 | 0.43 |
| W2 [μm] | 0.75 | 0.62 | 0.53 |
| W3 [μm] | 3.00 | 3.00 | 3.00 |
| W4 [μm] | 1.00 | 1.00 | 1.00 |
| W5 [μm] | 0.375 | 0.31 | 0.265 |
| W6 [μm] | 0.80 | 0.80 | 0.80 |

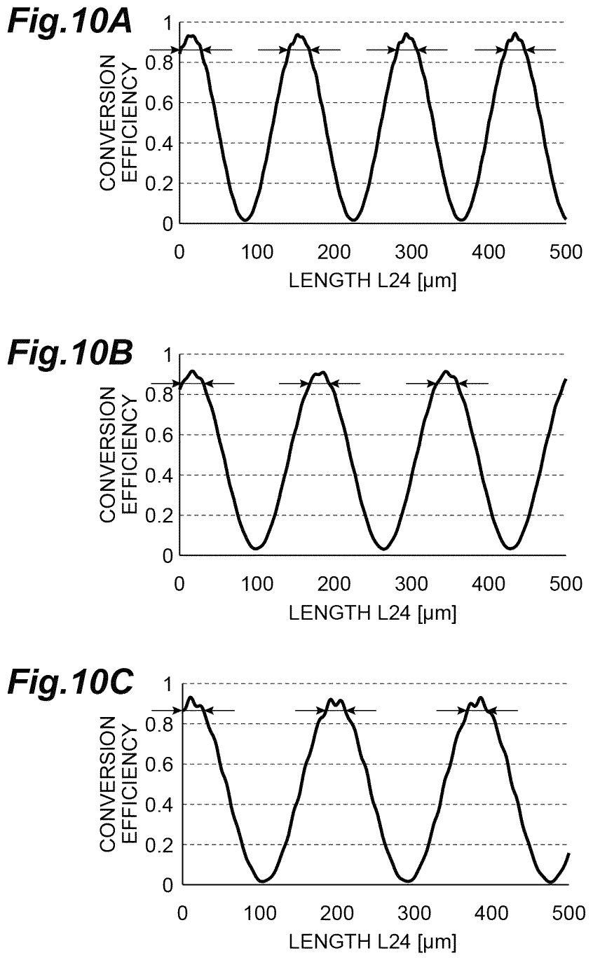

FIG. 10A illustrates a calculation result of red light, FIG. 10B illustrates a calculation result of green light, and FIG. 10C illustrates a calculation result of blue light. The vertical axes in FIGS. 10A, 10B, and 10C represent the conversion efficiency normalized by an ideal value (100%) of the conversion efficiency, and a unit thereof is arbitrary unit. The horizontal axes in FIGS. 10A, 10B, and 10C represent length L24 [μm].

As can be seen from FIGS. 10A, 10B, and 10C, the conversion efficiency of each of the red light, the green light, and the blue light periodically varies with respect to length L24 (length PL2). This is because when the length L22 and the length L24 are increased by the same amount, an absolute value of the optical path length difference ΔOL increases due to a difference between the effective refractive index n_{effA} in the waveguide 522 and the effective refractive index n_{effB}(s) in the waveguide 525. Therefore, when the optical path length difference ΔOL is in the range of −λ/3+nλ to −λ/6+nλ, in other words, when the phase difference Δφ is in the range of −2π/3+2nπ radians to −π/3+2nπ radians, it can be understood that high conversion efficiency of 86.6% or more can be obtained.

<Evaluation of Conversion Loss in Presence or Absence of Slab 41 and Evaluation of Length L1 of Conversion Unit 51>

In the conversion units 51 having the configurations of Examples 4 to 9, an influence of the presence or absence of the slab 41 on the conversion loss of TM0-TE1 conversion and the length L1 of the conversion unit 51 was evaluated. As the conversion units 51 of Examples 4 to 6, the conversion unit 51 having the same configuration as the configuration illustrated in FIGS. 4 and 5 was used. As the optical elements of Examples 7 to 9, the conversion units 51 having the same configuration as the configuration illustrated in FIGS. 4 and 5 except that the core layer CA did not include the slab 41 was used.

In Examples 4 to 9, as shown in Table 2, the height T1, the height T11, the length L1, the width W1, and the width W2 were set for wavelengths of the respective colors. The height T11 of 0 μm represents that the core layer CA does not include the slab 41. In Examples 4 to 9, in the conversion units 51 in which each parameter shown in Table 2 was set, the conversion loss in a case where the polarization mode of each of the red light, the green light, and the blue light is converted from the TM0 mode to the TE1 mode was calculated. The calculation results of the conversion loss are shown in Table 2.

TABLE 2

| | Exam- | Exam- | Exam- | Exam- | Exam- | Exam- |
|---|---|---|---|---|---|---|
| | ple 4 | ple 5 | ple 6 | ple 7 | ple 8 | ple 9 |
| Color | R | G | B | R | G | B |
| Wavelength | 638 | 520 | 455 | 638 | 520 | 455 |
| [nm] | | | | | | |
| T1 [μm] | 0.30 | 0.30 | 0.30 | 0.30 | 0.30 | 0.30 |
| T11 [μm] | 0.10 | 0.10 | 0.10 | 0.00 | 0.00 | 0.00 |
| L1 [μm] | 1000 | 1000 | 1000 | 1000 | 1000 | 1000 |
| W1 [μm] | 0.65 | 0.50 | 0.40 | 0.65 | 0.50 | 0.40 |
| W2 [μm] | 0.85 | 0.70 | 0.60 | 0.85 | 0.70 | 0.60 |
| Conversion | 0.01 | 0.00 | 0.15 | 5.76 | 7.69 | 9.63 |
| loss [dB] | | | | | | |

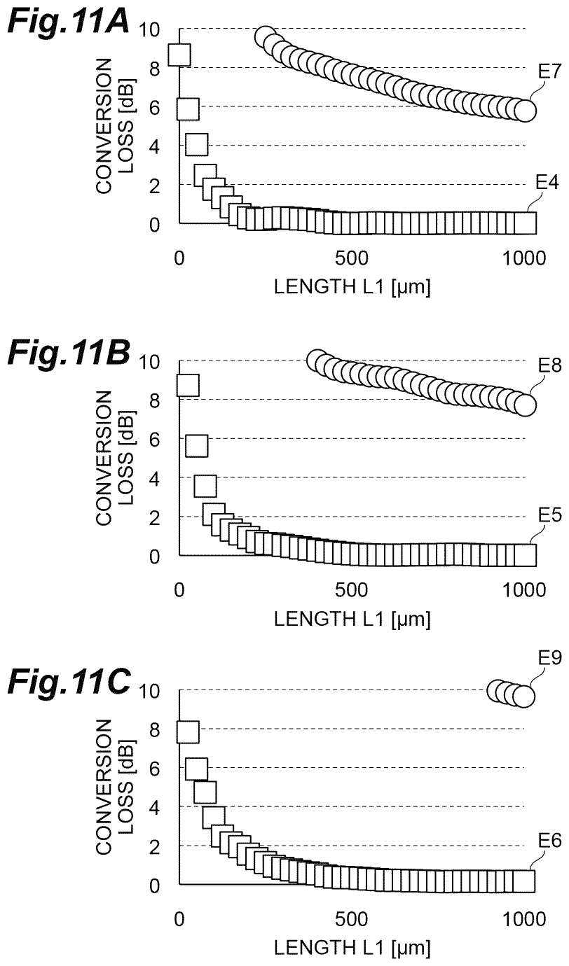

Furthermore, in the conversion unit 51 in which the height T1, the height T11, the width W1, and the width W2 were set as shown in Table 2, the conversion loss was calculated while changing the length L1. Calculation results of the red light are illustrated in FIG. 11A, calculation results of the green light are illustrated in FIG. 11B, and calculation results of the blue light are illustrated in FIG. 11C. The vertical axes in FIGS. 11A, 11B, and 11C represent the conversion loss [dB]. The horizontal axes in FIGS. 11A, 11B, and 11C represent the length L1 [μm].

In FIG. 11A, a plot E4 represents a relationship between the length L1 and the conversion loss in the conversion unit 51 in which the height T1, the height T11, the width W1, and the width W2 in Example 4 were set. In FIG. 11A, a plot E7 represents a relationship between the length L1 and the conversion loss in the conversion unit 51 in which the height T1, the height T11, the width W1, and the width W2 in Example 7 were set.

In FIG. 11B, a plot E5 represents a relationship between the length L1 and the conversion loss in the conversion unit 51 in which the height T1, the height T11, the width W1, and the width W2 in Example 5 were set. In FIG. 11B, a plot E8 represents a relationship between the length L1 and the conversion loss in the conversion unit 51 in which the height T1, the height T11, the width W1, and the width W2 in Example 8 were set.

In FIG. 11C, a plot E6 represents a relationship between the length L1 and the conversion loss in the conversion unit 51 in which the height T1, the height T11, the width W1, and the width W2 in Example 6 were set. In FIG. 11C, a plot E9 represents a relationship between the length L1 and the conversion loss in the conversion unit 51 in which the height T1, the height T11, the width W1, and the width W2 in Example 9 were set.

According to Table 2, in Examples 4 to 6, the conversion loss is further suppressed as compared with corresponding Examples among

### Examples 7 to 9. Therefore, it can be understood that the core layer CA

includes the slab 41, thereby suppressing a decrease in conversion efficiency for any of red light, green light, and blue light.

Further, according to FIGS. 11A, 11B, and 11C, in order to realize the same conversion loss, in Examples 4 to 6, the length L1 can be further reduced as compared with corresponding Examples among Examples 7 to 9. Therefore, it can be understood that by the core layer CA including the slab 41, the length L1 for realizing a predetermined conversion loss can be reduced, and the lengths of the mode converters 45, 46, and 47 in the X-axis direction can be reduced.

### <Evaluation of Conversion Loss at Height T1 of Core Layer CA and Evaluation of Length L1 of Conversion Unit 51>

By using the mode converters having the configurations of Examples 10 to 13, the influence of the height T1 on the conversion loss and the length L1 in the red light was evaluated. As the mode converter of Example 10, a mode converter having the same configuration as the configuration illustrated in FIGS. 4 to 6 was used except that the configuration in which the width of the waveguide 521 increases from the end 521a toward the end 521b and the configuration in which the width of the waveguide 523 increases from the end 523a toward the end 523b was adopted. As the mode converters of Examples 11 to 13, mode converters having the same configuration as that of Example 10 was used except that the configuration in which the width of the waveguide 525 decreases from the width W6 to the width W4 from the end 525a toward the end 525b were adopted. Further, in the mode converters of Examples 10 to 13, the width W5 was set to 50% of the width W2, and the width at the end 521a was set to be substantially the same as the width W5.

In Examples 10 to 13, as shown in Table 3, the height T1, the height T11, the length L21, the length L22, the length L23, the length L24, the length L25, the length L3, the width W1, the width W2, the width W3, the width W4, the width W5, and the width W6 were set for the red light. Note that, the wavelength of the red light was 638 nm. In Examples 10 to 13, in the optical elements in which each parameter shown in Table 3 were set, the conversion loss in a case where the polarization mode of the red light is converted from the TM0 mode to the TE0 mode was calculated. The length L1 at which the conversion loss is minimized and the calculation result of the minimum conversion loss are shown in Table 3.

TABLE 3

| | Example 10 | Example 11 | Example 12 | Example 13 |
|---|---|---|---|---|
| T1 [μm] | 0.30 | 0.45 | 0.80 | 0.90 |
| T11 [μm] | 0.10 | 0.15 | 0.20 | 0.20 |
| L21 [μm] | 31.0 | 39.0 | 28.0 | 23.0 |
| L22 [μm] | 37.0 | 48.0 | 80.0 | 80.0 |
| L23 [μm] | 10.0 | 10.0 | 10.0 | 10.0 |
| L24 [μm] | 17.0 | 28.0 | 60.0 | 60.0 |
| L25 [μm] | 10.0 | 10.0 | 10.0 | 10.0 |
| L3 [μm] | 64.5 | 90.0 | 90.0 | 90.0 |
| W1 [μm] | 0.65 | 0.70 | 0.80 | 0.80 |
| W2 [μm] | 0.75 | 0.80 | 0.90 | 0.90 |
| W3 [μm] | 3.00 | 2.00 | 2.00 | 2.00 |
| W4 [μm] | 1.00 | 0.50 | 0.50 | 0.50 |
| W5 [μm] | 0.375 | 0.40 | 0.45 | 0.45 |
| W6 [μm] | 0.80 | 0.60 | 0.60 | 0.60 |
| Conversion | 0.31 | 0.57 | 3.71 | 4.00 |
| loss [dB] | | | | |
| L1 [μm] | 225 | 370 | 4700 | 12400 |

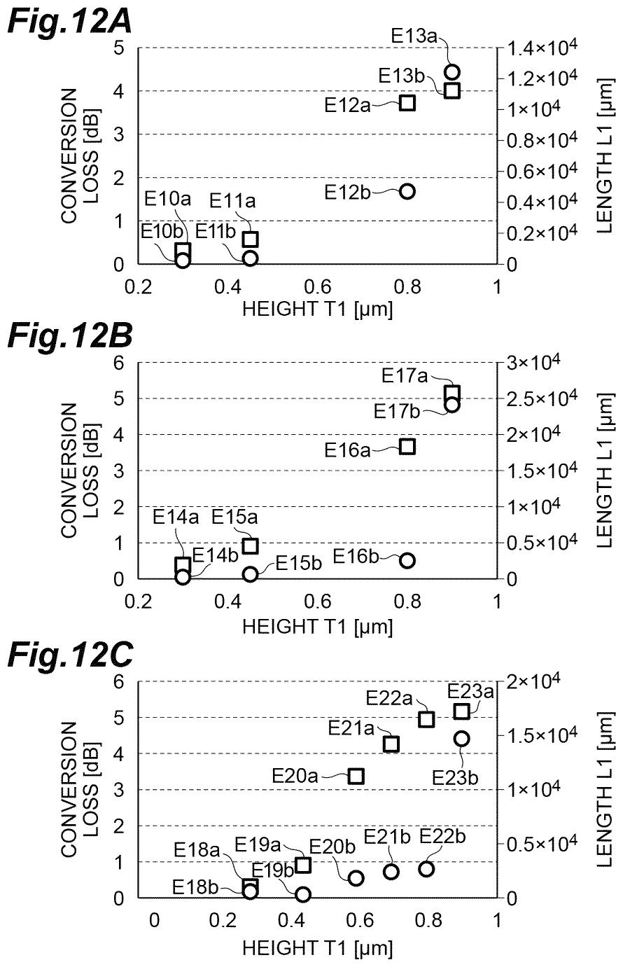

Further, among the parameters shown in Table 3, a relationship 10 between the height T1 and the conversion loss and a relationship between the height T1 and the length L1 are illustrated in FIG. 12A. The left vertical axis in FIG. 12A represents the conversion loss [dB], the right vertical axis in FIG. 12A represents the length L1 [μm], and the horizontal axis in FIG. 12A represents the height T1 [μm].

A plot E10a represents the relationship between the height T1 and the conversion loss in Example 10. A plot E10b represents the relationship between the height T1 and the length L1 in Example 10. A plot Ella represents the relationship between the height T1 and the conversion loss in Example 11. A plot E11b represents the relationship between the height T1 and the length L1 in Example 11. A plot E12a represents the relationship between the height T1 and the conversion loss in Example 12. A plot E12b represents the relationship between the height T1 and the length L1 in Example 12. A plot E13a represents the relationship between the height T1 and the conversion loss in Example 13. A plot E13b represents the relationship between the height T1 and the length L1 in Example 13.

Hereinafter, it is assumed that high conversion efficiency is achieved when the conversion loss is smaller than 1.00 dB, and that the length L1 is suppressed when the length L1 is smaller than 1000 μm.

According to Table 3 and FIG. 12A, the conversion losses in Examples 10 and 11 in which the height T1 was smaller than the wavelength (638 nm) of the red light were 0.31 dB to 0.57 dB. On the other hand, the conversion losses in Examples 12 and 13 in which the height T1 was equal to or more than the wavelength of the red light were 3.71 dB to 4.00 dB. Therefore, it can be understood that in the red light, high conversion efficiency is achieved when the height T1 is smaller than the wavelength of the red light.

Furthermore, the lengths L1 in Examples 10 and 11 in which the height T1 was smaller than the wavelength of red light were 225 μm to 370 μm. On the other hand, the lengths L1 in Examples 12 and 13 in which the height T1 was equal to or more than the wavelength of red light were 4700 μm to 12400 μm. Therefore, it can be understood that in the red light, when the height T1 is smaller than the wavelength of the red light, the length L1 can be reduced, and the length of the mode converter 45 in the X-axis direction can be reduced.

By using the mode converters having the configurations of Examples 14 to 17, the influence of the height T1 on the conversion loss and the length L1 in the green light was evaluated. As the mode converter of Example 14, a mode converter having the same configuration as the configuration illustrated in FIGS. 4 to 6 was used except that the configuration in which the width of the waveguide 521 increases from the end 521a toward the end 521b and the configuration in which the width of the waveguide 523 increases from the end 523a toward the end 523b were adopted. As the mode converters of Examples 15 to 17, a mode converter having the same configuration as that of Example 14 was used except that the configuration in which the width of the waveguide 525 decreases from the end 525a toward the end 525b was adopted. Further, in the mode converters of Examples 14 to 17, the width W5 was set to 50% of the width W2, and the width at the end 521a was set to be substantially the same as the width W5.

In Examples 14 to 17, as shown in Table 4, the height T1, the height T11, the length L21, the length L22, the length L23, the length L24, the length L25, the length L3, the width W1, the width W2, the width W3, the width W4, the width W5, and the width W6 were set for the green light. A wavelength of the green light was 520 nm. In Examples 14 to 17, in the optical elements in which each parameter shown in Table 4 was set, the conversion loss in a case where the polarization mode of the green light is converted from the TM0 mode to the TE0 mode was calculated. The length L1 at which the conversion loss is minimized and the calculation result of the minimum conversion loss are shown in Table 4.

TABLE 4

| | Example 14 | Example 15 | Example 16 | Example 17 |
|---|---|---|---|---|
| T1 [μm] | 0.30 | 0.45 | 0.80 | 0.90 |
| T11 [μm] | 0.10 | 0.15 | 0.20 | 0.20 |
| L21 [μm] | 32.0 | 50.0 | 43.0 | 35.0 |
| L22 [μm] | 36.0 | 28.0 | 80.0 | 80.0 |
| L23 [μm] | 10.0 | 10.0 | 10.0 | 10.0 |
| L24 [μm] | 16.0 | 8.0 | 60.0 | 60.0 |
| L25 [μm] | 10.0 | 10.0 | 10.0 | 10.0 |
| L3 [μm] | 81.0 | 112.0 | 112.0 | 112.0 |
| W1 [μm] | 0.52 | 0.52 | 0.60 | 0.60 |
| W2 [μm] | 0.62 | 0.62 | 0.80 | 0.80 |
| W3 [μm] | 3.00 | 2.00 | 2.00 | 2.00 |
| W4 [μm] | 1.00 | 0.50 | 0.50 | 0.50 |
| W5 [μm] | 0.31 | 0.31 | 0.40 | 0.40 |
| W6 [μm] | 0.80 | 0.60 | 0.60 | 0.60 |
| Conversion | 0.38 | 0.97 | 3.66 | 5.13 |
| loss [dB] | | | | |
| L1 [μm] | 212 | 614 | 2500 | 24100 |

Further, among the parameters shown in Table 4, a relationship between the height T1 and the conversion loss and a relationship between the height T1 and the length L1 are illustrated in FIG. 12B. The left vertical axis in FIG. 12B represents the conversion loss [dB], the right vertical axis in FIG. 12B represents the length L1 [μm], and the horizontal axis in FIG. 12B represents the height T1 [μm].

A plot E14a represents the relationship between the height T1 and the conversion loss in Example 14. A plot E14b represents the relationship between the height T1 and the length L1 in Example 14. A plot E15a represents the relationship between the height T1 and the conversion loss in Example 15. A plot E15b represents the relationship between the height T1 and the length L1 in Example 15. A plot E16a represents the relationship between the height T1 and the conversion loss in Example 16. A plot E16b represents the relationship between the height T1 and the length L1 in Example 16. A plot E17a represents the relationship between the height T1 and the conversion loss in Example 17. A plot E17b represents the relationship between the height T1 and the length L1 in Example 17.

According to Table 4 and FIG. 12B, the conversion losses in Examples 14 and 15 in which the height T1 was smaller than the wavelength (520 nm) of the green light were 0.38 dB to 0.97 dB. On the other hand, the conversion losses in Examples 16 and 17 in which the height T1 was equal to or more than the wavelength of the green light were 3.66 dB to 5.13 dB. Therefore, it can be understood that even in the green light, high conversion efficiency is achieved when the height T1 is smaller than the wavelength of the green light.

Furthermore, the lengths L1 in Examples 14 and 15 in which the height T1 was smaller than the wavelength of the green light were 212 μm to 614 μm. On the other hand, the lengths L1 in Examples 16 and 17 in which the height T1 was equal to or more than the wavelength of the green light were 2500 μm to 24100 μm. Therefore, it can be understood that even in the green light, when the height T1 is smaller than the wavelength of the green light, the length L1 can be reduced, and the length of the mode converter 46 in the X-axis direction can be reduced.

By using the mode converters having the configurations of Examples 18 to 23, the influence of the height T1 on the conversion loss and the length L1 in the blue light was evaluated. As the mode converter of Example 18, a mode converter having the same configuration as the configuration illustrated in FIGS. 4 to 6 was used except that the configuration in which the width of the waveguide 521 increases from the end 521a toward the end 521b and the configuration in which the width of the waveguide 523 increases from the end 523a toward the end 523b were adopted. As the mode converters of Examples 19 to 23, a mode converter having the same configuration as that of Example 18 was used except that the configuration in which the width of the waveguide 525 decreases from the end 525a toward the end 525b was adopted. Further, in the mode converters of Examples 18 to 23, the width W5 was set to 50% of the width W2, and the width at the end 521a was set to be substantially the same as the width W5.

In Examples 18 to 23, as shown in Table 5, the height T1, the height T11, the length L21, the length L22, the length L23, the length L24, the length L25, the length L3, the width W1, the width W2, the width W3, the width W4, the width W5, and the width W6 were set for the blue light. In Examples 18 to 23, the wavelength of the blue light was 455 nm. In Examples 18 to 23, in the optical element in which each parameter shown in Table 5 was set, the conversion loss in a case where the polarization mode of the blue light is converted from the TM0 mode to the TE0 mode was calculated. The length L1 at which the conversion loss is minimized and the calculation result of the minimum conversion loss are shown in Table 5.

TABLE 5

| | Exam- | Exam- | Exam- | Exam- | Exam- | Exam- |
|---|---|---|---|---|---|---|
| | ple 18 | ple 19 | ple 20 | ple 21 | ple 22 | ple 23 |
| T1 [μm] | 0.30 | 0.45 | 0.60 | 0.70 | 0.80 | 0.90 |
| T11 [μm] | 0.10 | 0.15 | 0.15 | 0.15 | 0.15 | 0.15 |
| L21 [μm] | 34.0 | 37.0 | 32.0 | 32.0 | 32.0 | 49.0 |
| L22 [μm] | 30.0 | 51.0 | 56.0 | 54.0 | 51.0 | 59.0 |
| L23 [μm] | 10.0 | 10.0 | 10.0 | 10.0 | 10.0 | 10.0 |
| L24 [μm] | 10.0 | 31.0 | 36.0 | 34.0 | 31.0 | 39.0 |
| L25 [μm] | 10.0 | 10.0 | 10.0 | 10.0 | 10.0 | 10.0 |
| L3 [μm] | 95.0 | 130.0 | 129.0 | 128.0 | 128.0 | 128.0 |
| W1 [μm] | 0.43 | 0.40 | 0.50 | 0.50 | 0.50 | 0.50 |
| W2 [μm] | 0.53 | 0.50 | 0.60 | 0.60 | 0.60 | 0.60 |
| W3 [μm] | 3.00 | 2.00 | 2.00 | 2.00 | 2.00 | 2.00 |
| W4 [μm] | 1.00 | 0.50 | 0.50 | 0.50 | 0.50 | 0.50 |
| W5 [μm] | 0.265 | 0.25 | 0.30 | 0.30 | 0.30 | 0.30 |
| W6 [μm] | 0.80 | 0.60 | 0.60 | 0.60 | 0.60 | 0.60 |
| Conversion | 0.31 | 0.89 | 3.37 | 4.26 | 4.94 | 5.16 |
| loss [dB] | | | | | | |
| L1 [μm] | 572 | 300 | 1800 | 2400 | 2650 | 14700 |

Further, among the parameters shown in Table 5, a relationship between the height T1 and the conversion loss and a relationship between the height T1 and the length L1 are illustrated in FIG. 12C. The left vertical axis in FIG. 12C represents the conversion loss [dB], the right vertical axis in FIG. 12C represents the length L1 [μm], and the horizontal axis in FIG. 12C represents the height T1 [μm].

A plot E18a represents the relationship between the height T1 and the conversion loss in Example 18. A plot E18b represents the relationship between the height T1 and the length L1 in Example 18. A plot E19a represents the relationship between the height T1 and the conversion loss in Example 19. A plot E19b represents the relationship between the height T1 and the length L1 in Example 19. A plot E20a represents the relationship between the height T1 and the conversion loss in Example 20. A plot E20b represents the relationship between the height T1 and the length L1 in Example 20. A plot E21a represents the relationship between the height T1 and the conversion loss in Example 21. A plot E21b represents the relationship between the height T1 and the length L1 in Example 21. A plot E22a represents the relationship between the height T1 and the conversion loss in Example 22. A plot E22b represents the relationship between the height T1 and the length L1 in Example 22. A plot E23a represents the relationship between the height T1 and the conversion loss in Example 23. A plot E23b represents the relationship between the height T1 and the length L1 in Example 23.

According to Table 5 and FIG. 12C, the conversion losses in Examples 18 and 19 in which the height T1 was smaller than the wavelength (455 nm) of the blue light were 0.31 dB to 0.89 dB. On the other hand, the conversion losses in Examples 20 to 23 in which the height T1 was equal to or more than the wavelength of the blue light were 3.37 dB to 5.16 dB. Therefore, it can be understood that even in the blue light, high conversion efficiency is achieved when the height T1 is smaller than the wavelength of blue light.

Furthermore, the lengths L1 in Examples 18 and 19 in which the height T1 was smaller than the wavelength of the blue light were 300 μm to 570 μm. On the other hand, the lengths L1 in Examples 20 to 23 in which the height T1 was equal to or more than the wavelength of the blue light were 1800 μm to 14700 μm. Therefore, it can be understood that even in the blue light, when the height T1 is smaller than the wavelength of the blue light, the length L1 can be reduced, and the length of the mode converter 47 in the X-axis direction can be reduced.

Note that, in Examples 10 to 23, the parameters other than the height T1 were also changed, but the parameters other than the height T1 shown in Tables 3, 4, and 5 were values set so that the optical path length difference ΔOL becomes −λ/4+nλ and the conversion loss is minimized when the color of the visible light and the height T1 were changed. Therefore, it is considered that the influence on the conversion efficiency due to variation in the parameters other than the height T1 is negligibly small.

### (Additional Statements)

[Clause 1]

An optical element comprising:
a substrate including a main surface; and
a core layer that is provided on the main surface and consists of a material having an electro-optical effect,
wherein the core layer includes a mode converter extending in a first direction along the main surface, the mode converter configured to convert a polarization mode of visible light from a TM0 mode to a TE0 mode,
the mode converter includes:
a conversion unit configured to convert the polarization mode of the visible light from the TM0 mode to a TE1 mode;
a splitting unit configured to split the visible light in the TE1 mode into a first split light in the TE0 mode and a second split light in the TE0 mode, and to adjust a phase difference between the first split light and the second split light; and
a multiplexing unit configured to multiplex the first split light and the second split light,
the conversion unit includes a first end to which the visible light in the TM0 mode is incident, and a second end from which the visible light in the TE1 mode is emitted, the first end and the second end being both ends in the first direction,
a length of the conversion unit in a second direction along the main surface and intersecting the first direction continuously increases from the first end to the second end,
the phase difference is a phase difference obtained by subtracting a phase of the first split light when incident to the multiplexing unit from a phase of the second split light when incident to the multiplexing unit,
the splitting unit includes a first branch wave guide through which the first split light propagates and a second branch wave guide through which the second split light propagates, and
an optical path length of the first split light in the first branch wave guide and an optical path length of the second split light in the second branch wave guide are different from each other.

[Clause 2]

The optical element according to Clause 1,
wherein the phase difference is −2π/3+2nπ radians or more and −π/3+2nπ radians or less, and
n is an integer.

[Clause 3]

The optical element according to Clause 1, or 2
wherein the core layer further includes a slab provided on the main surface, and
the mode converter is provided on the slab in a third direction intersecting the first direction and the second direction.

[Clause 4]

The optical element according to Clause 3,
wherein a length of the core layer in the third direction is smaller than a wavelength of the visible light.

[Clause 5]

The optical element according to any one of Clauses 1 to 4,
wherein the multiplexing unit includes a multimode interferometer.

[Clause 6]

The optical element according to Clause 5,
wherein a length of the multiplexing unit in the second direction is 2.0 μm or more.

[Clause 7]

The optical element according to Clause 5 or 6,
wherein a length of the first branch wave guide in the second direction at a connection end connected to the multiplexing unit of the first branch wave guide is 23% or more and 47% or less of a length of the multiplexing unit in the second direction, and
a length of the second branch wave guide in the second direction at a connection end connected to the multiplexing unit of the second branch wave guide is 23% or more to 47% or less of the length of the multiplexing unit in the second direction.

[Clause 8]

The optical element according to any one of Clauses 1 to 7,
wherein the core layer includes:
a first mode converter that is the mode converter configured to convert a polarization mode of red light from the TM0 mode to the TE0 mode;
a second mode converter that is the mode converter configured to convert a polarization mode of green light from the TM0 mode to the TE0 mode;
a third mode converter that is the mode converter configured to convert a polarization mode of blue light from the TM0 mode to the TE0 mode; and
a multiplexer configured to multiplex the red light, the green light, and the blue light to emit laser light.

[Clause 9]

The optical element according to Clause 8,
wherein a length of the first mode converter in a third direction intersecting the first direction and the second direction, a length of the second mode converter in the third direction, and a length of the third mode converter in the third direction are the same as each other.

[Clause 10]

The optical element according to Clause 8 or 9,
wherein the core layer further includes:
a first modulator configured to modulate an optical intensity of the red light;
a second modulator configured to modulate an optical intensity of the green light; and
a third modulator configured to modulate an optical intensity of the blue light.

[Clause 11]

A laser module comprising:
the optical element according to claim 8;
a first laser light source configured to emit the red light in the TM0 mode,
a second laser light source configured to emit the green light in the TM0 mode, and
a third laser light source configured to emit the blue light in the TM0 mode.

[Clause 12]

A retinal projection device mounted on a near-eye wearable device, the retinal projection device comprising:
the laser module according to claim 11;
a movable mirror configured to perform scanning by using the laser light emitted from the laser module; and
a reflector configured to reflect the laser light that has passed through the movable mirror and to guide the laser light to a retina of a user wearing the near-eye wearable device to project an image onto the retina.

[Clause 13]

A near-eye wearable device comprising:
the retinal projection device according to claim 12; and
a lens provided with the reflector.

What is claimed is:

1. An optical element comprising:
a substrate including a main surface; and
a core layer that is provided on the main surface and consists of a material having an electro-optical effect,
wherein the core layer includes a mode converter extending in a first direction along the main surface, the mode converter configured to convert a polarization mode of visible light from a TM0 mode to a TE0 mode,
the mode converter includes:
a conversion unit configured to convert the polarization mode of the visible light from the TM0 mode to a TE1 mode;
a splitting unit configured to split the visible light in the TE1 mode into a first split light in the TE0 mode and a second split light in the TE0 mode, and to adjust a phase difference between the first split light and the second split light; and
a multiplexing unit configured to multiplex the first split light and the second split light,
the conversion unit includes a first end to which the visible light in the TM0 mode is incident, and a second end from which the visible light in the TE1 mode is emitted, the first end and the second end being both ends in the first direction,
a length of the conversion unit in a second direction along the main surface and intersecting the first direction continuously increases from the first end to the second end,
the phase difference is a phase difference obtained by subtracting a phase of the first split light when incident to the multiplexing unit from a phase of the second split light when incident to the multiplexing unit,
the splitting unit includes a first branch wave guide through which the first split light propagates and a second branch wave guide through which the second split light propagates, and
an optical path length of the first split light in the first branch wave guide and an optical path length of the second split light in the second branch wave guide are different from each other.

2. The optical element according to claim 1,
wherein the phase difference is −2π/3+2nπ radians or more and −π/3+2nπ radians or less, and
n is an integer.

3. The optical element according to claim 1,
wherein the core layer further includes a slab provided on the main surface, and
the mode converter is provided on the slab in a third direction intersecting the first direction and the second direction.

4. The optical element according to claim 3,
wherein a length of the core layer in the third direction is smaller than a wavelength of the visible light.

5. The optical element according to claim 1,
wherein the multiplexing unit includes a multimode interferometer.

6. The optical element according to claim 5,
wherein a length of the multiplexing unit in the second direction is 2.0 μm or more.

7. The optical element according to claim 5,
wherein a length of the first branch wave guide in the second direction at a connection end connected to the multiplexing unit of the first branch wave guide is 23% or more and 47% or less of a length of the multiplexing unit in the second direction, and
a length of the second branch wave guide in the second direction at a connection end connected to the multiplexing unit of the second branch wave guide is 23% or more to 47% or less of the length of the multiplexing unit in the second direction.

8. The optical element according to claim 1,
wherein the core layer includes:
a first mode converter that is the mode converter configured to convert a polarization mode of red light from the TM0 mode to the TE0 mode;
a second mode converter that is the mode converter configured to convert a polarization mode of green light from the TM0 mode to the TE0 mode;
a third mode converter that is the mode converter configured to convert a polarization mode of blue light from the TM0 mode to the TE0 mode; and
a multiplexer configured to multiplex the red light, the green light, and the blue light to emit laser light.

9. The optical element according to claim 8,
wherein a length of the first mode converter in a third direction intersecting the first direction and the second direction, a length of the second mode converter in the third direction, and a length of the third mode converter in the third direction are the same as each other.

10. The optical element according to claim 8,
wherein the core layer further includes:
a first modulator configured to modulate an optical intensity of the red light;
a second modulator configured to modulate an optical intensity of the green light; and
a third modulator configured to modulate an optical intensity of the blue light.

11. A laser module comprising:
the optical element according to claim 8;
a first laser light source configured to emit the red light in the TM0 mode,
a second laser light source configured to emit the green light in the TM0 mode, and
a third laser light source configured to emit the blue light in the TM0 mode.

12. A retinal projection device mounted on a near-eye wearable device, the retinal projection device comprising:
the laser module according to claim 11;
a movable mirror configured to perform scanning by using the laser light emitted from the laser module; and
a reflector configured to reflect the laser light that has passed through the movable mirror and to guide the laser light to a retina of a user wearing the near-eye wearable device to project an image onto the retina.

13. A near-eye wearable device comprising:
the retinal projection device according to claim 12; and
a lens provided with the reflector.
